(19) United States
(12) Patent Application Publication
(10) Pub. No.: US 2024/0202600 A1
(43) Pub. Date: Jun. 20, 2024

(54) MACHINE LEARNING MODEL ADMINISTRATION AND OPTIMIZATION

(71) Applicant: C3.ai, Inc., Redwood City, CA (US)

(72) Inventors: Louis Poirier, Paris (FR); Sina Pakazad, Redwood City, CA (US); John Abelt, San Francisco, CA (US); Aliakbar Panahi, Redwood City, CA (US); Michael Haines, San Mateo, CA (US); Romain Juban, San Francisco, CA (US); Yushi Homma, Santa Clara, CA (US); Riyad Muradov, Foster City, CA (US)

(21) Appl. No.: 18/542,676

(22) Filed: Dec. 16, 2023

Related U.S. Application Data
(60) Provisional application No. 63/433,124, filed on Dec. 16, 2022.
(60) Provisional application No. 63/446,792, filed on Feb. 17, 2023.
(60) Provisional application No. 63/492,133, filed on Mar. 24, 2023.

(51) Int. Cl. G06N 20/00; G06N 5/04

(52) U.S. Cl. CPC G06N 20/00; G06N 5/04

(57) ABSTRACT

Systems and methods for a model inference service system that provides a technical solution for deploying and updating trained machine-learning models with support for specific use case deployments and implementations at scale with efficient processing. The model inference service system includes a hierarchical model registry for versioning models and model dependencies for each versioned model, a model inference service for rapidly deploying model instances in run-time environments, and a model processing system for managing multiple instances of deployed models. Changes to deployed models are captured as new versions in the hierarchical model registry.

### CROSS-REFERENCE TO RELATED APPLICATIONS

The present application claims the benefit of U.S. Provisional Patent Application Ser. No. 63/433,124 filed Dec. 16, 2022 and entitled “Unbounded Data Model Query Handling and Dispatching Action in a Model Driven Architecture,” U.S. Provisional Patent Application Ser. No. 63/446,792 filed Feb. 17, 2023 and entitled “System and Method to Apply Generative AI to Transform Information Access and Content Creation for Enterprise Information Systems,” and U.S. Provisional Patent Application Ser. No. 63/492,133 filed Mar. 24, 2023 and entitled “Iterative Context-based Generative Artificial Intelligence,” each of which is hereby incorporated by reference herein.

### TECHNICAL FIELD

This disclosure pertains to machine learning models (e.g., multimodal generative artificial intelligence models, large language models, video models, audio models, audiovisual models, statistical models, and the like). More specifically, this disclosure pertains to systems and methods for machine learning model administration and optimization.

### BACKGROUND

Under conventional approaches, computing systems can deploy and execute models. However, conventional approaches are computationally inefficient and expensive (e.g., memory requirements, CPU requirements, GPU requirements). For example, large computing clusters with massive amounts of computing resources are typically required to execute large models and they cannot consistently function efficiently (e.g., with low latency and without consuming excessive amounts of computing resources).

### BRIEF DESCRIPTION OF THE DRAWINGS

FIG. 1 depicts a diagram of an example model inference service and run-time environment according to some embodiments.

FIGS. 2A-B depict diagrams of an example structure of a model registry according to some embodiments.

FIG. 3 depicts a diagram of an example network system for machine learning model administration and optimization using a model inference service system according to some embodiments.

FIG. 4 depicts a diagram of an example model inference service system according to some embodiments.

FIG. 5 depicts a diagram of an example computing environment including a central model registry environment and a target model registry environment according to some embodiments.

FIG. 6A depicts a diagram of an example model processing system implementing a model pre-loading process according to some embodiments.

FIG. 6B depicts a diagram of an automatic model load-balancing process according to some embodiments.

FIG. 7 depicts a flowchart of an example method of model administration according to some embodiments.

FIG. 8 depicts a flowchart of an example method of model load-balancing according to some embodiments.

FIG. 9 depicts a flowchart of an example method of operation of a model registry according to some embodiments.

FIG. 10 depicts a flowchart of an example method of model administration according to some embodiments.

FIG. 11 depicts a flowchart of an example method of model swapping according to some embodiments.

FIG. 12 depicts a flowchart of an example method of model processing system and/or model processing unit swapping according to some embodiments.

FIGS. 13A-C depict flowcharts of example methods of model compression and decompression according to some embodiments.

FIG. 14 depicts a flowchart of an example method of predictive model load balancing according to some embodiments.

FIG. 15 is a diagram of an example computer system for implementing the features disclosed herein according to some embodiments.

### DETAILED DESCRIPTION

Conventional systems can deploy and execute a variety of different models, such as large language models, multimodal models, and other types of machine learning models. These models often have billions of parameters and are typically executed on state-of-the-art graphics processing units (GPUs). Even with state-of-the-art GPUs, processing of the models and hardware can be costly, in high demand, and quickly overwhelmed. Approaches attempt to address model processing demand with multiple GPUs at significant computational cost (e.g., large amounts of memory, energy, funding, etc.). Further GPUs may sit idle when the number of requests inevitably decrease. Idle GPUs can remain for minutes, hours, days, or even longer, leading to untenable amounts computational waste and inefficiency. Approaches to large scale model processing suffer from significant technical problems involving excessive computational resources with significant computational waste, or excessive request latency.

Described herein is a model inference service system that provides a technical solution for deploying trained machine-learning models with support for specific use case deployments and implementations at scale with efficient processing. The model inference service system includes a model registry for versioning models and model dependencies for each versioned model, a model inference service for rapidly deploying model instances in run-time environments, and a model processing system for managing multiple instances of deployed models. Example aspects of the model inference service system include storage and deployment management such as versioning, pre-loading, model swapping, model compression, and predictive model deployment load balancing as described herein. The model inference service system includes technical deployment solution that can efficiently process model requests (e.g., based on guaranteed threshold latency) while also consuming fewer computing resources, minimizing costs and computational waste.

Machine learning models can be trained using a base set of data and then retrained or fine-tuned with premier data. In an example implementation, a base model (e.g., a multimodal model, a large language model) is trained with base data for a general use case and retrained or fine-tuned with premier data for a specific sub-use case. In other examples, the base model is trained with base data that is general or less sensitive and retrained or fine-tuned with premier data that is more specific, specialized, confidential, etc. Multiple versions as well as versions of versions of models can be stored and managed to efficiently configure, re-train, and fine-tune models at scale for enterprise operations. This model inference service system enables large scale complex model processing operations with reduced resources and costs.

The model registry of the inference service system enables training, tuning, versioning, updating, and deploying machine learning models. The model registry retains deltas of model versions for efficient storage and use-case specific deployment. The model registry manages versions of models to be deployed across multiple domains or use cases minimizing processing costs. The model inference service can be used in enterprise environments to curate libraries of trained models that are fine-tuned and deployed for specific use cases.

The model inference service system can leverage specifically configured model registries to achieve the technical benefits such as low latency with fewer computing resources and less computational waste. Model registries can store many different types of multimodal models, such as large language models that can generate natural language responses, vision models that can generate image data, audio models that can generate audio data, transcription models that can generate transcriptions of audio data or video data, and other types of machine learning models. The model registry can also store metadata describing the models, and the model registry can store different versions of the models in a hierarchical structure to provide efficient storage and retrieval of the different models. For example, a baseline model can include all of the parameters (e.g., billions of weights of a multimodal or large language model), and the subsequent versions of that model may only include the parameters that have changed. This can allow the model inference service system to store and deploy models more efficiently than traditional systems.

The model inference service system can compress models which can be stored in the model registry and deployed to various model processing systems (e.g., edge devices of an enterprise network or other model processing systems) in the compressed format. The compressed models are then decompressed (e.g., at run-time) by the model processing systems. Compressed models can have a much smaller memory footprint (e.g., four times smaller) than existing large language models, while suffering little, if any, performance loss (e.g., based on LAMBADA PPL evaluation).

The model inference service system can deploy models to different enterprise network environments, including for cloud, on premise or air-gapped environments. The model inference service system can deploy models to edge devices (e.g., mobile phones, routers, computers, etc.) which may have much fewer computing resources than the servers that commonly host large models (e.g., edge devices that cannot execute large models). However, the model inference service system can generate compressed models and systems to effectively be deployed and executed on a single GPU or a single CPU device with limited memory (e.g., edge devices, and mobile phones). The compressed models can also be effectively deployed and executed in cloud, on premise or air-gapped environments or on a mobile device and function with or without network connections.

The model inference service system intelligently manages the number of executing models when the current or predicted demand for the model changes. The model inference service system can automatically increase or decrease the number of executing models to meet a current or predicted demand for the model, which can allow the systems to consistently process requests at low latency. In response to the volume of requests crossing a threshold amount, or if model request latency crosses a threshold amount, and/or if computational utilization (e.g., memory utilization) crosses a threshold amount, then the model inference service system can automatically trigger various model load-balancing operations, such as deploying and executing additional instances of the model on other GPUs, terminating execution of model instances, executing model instances on different hardware (e.g., one or more other GPUs with more memory or other computing resources), and the like.

An example aspect includes a model registry with a hierarchical repository of base models with versioning for base models along with model dependencies for each versioned model. A base model (or, baseline model) can be versioned for different use cases, users, organizations, etc. Versioned models are generally smaller than the base model and can include only specific deltas or differences (e.g., relative to the base model or intervening model). A model inference service for rapidly deploying model instances in run-time environments a model processing system for managing multiple instances of deployed models. In response to a request to instantiate a versioned model, the selected version can be combined with the base model, dependencies, and optionally one or more sub-versions to be instantiate a complete specific model for the request. Versioned models and the associated dependencies can be updated continuously or intermittently during execution sessions and/or in between sessions. The model inference service can analyze and evaluate module usage (feedback, session data, performance, etc.) to determine updates the model registry for a model.

In an example, a model inference service can deploy a single version of a model for multiple users in one or more instantiated sessions. The model inference service can determine to update the model registry with one or additional versions based on the use of the model in the instantiated sessions by the multiple users. The model inference service can also determine a subset of sessions to combine or ignore to determine to update the model registry with new versions. In an example, the model inference service uses a single version of a model that is simultaneously deployed in different sessions (e.g., for different users, use cases, organizations, etc.). The model inference service analyzes and evaluates the module usage to update the model registry with data and determine to separately version, combine, or discard data from one of the sessions or subset sessions.

To deploy a version of a model, the model inference service may be called by an application request. In an example implementation, a suite of enterprise AI applications can provide predictive insights using machine learning models. The enterprise AI applications can include generative machine learning and multimodal models to service and generate requests. The model inference service uses metadata associated to that request (e.g., user profile, organizational information, access rights, permissions, etc.). The model inference service traverses the model registry to select a base model and determine versioned deltas.

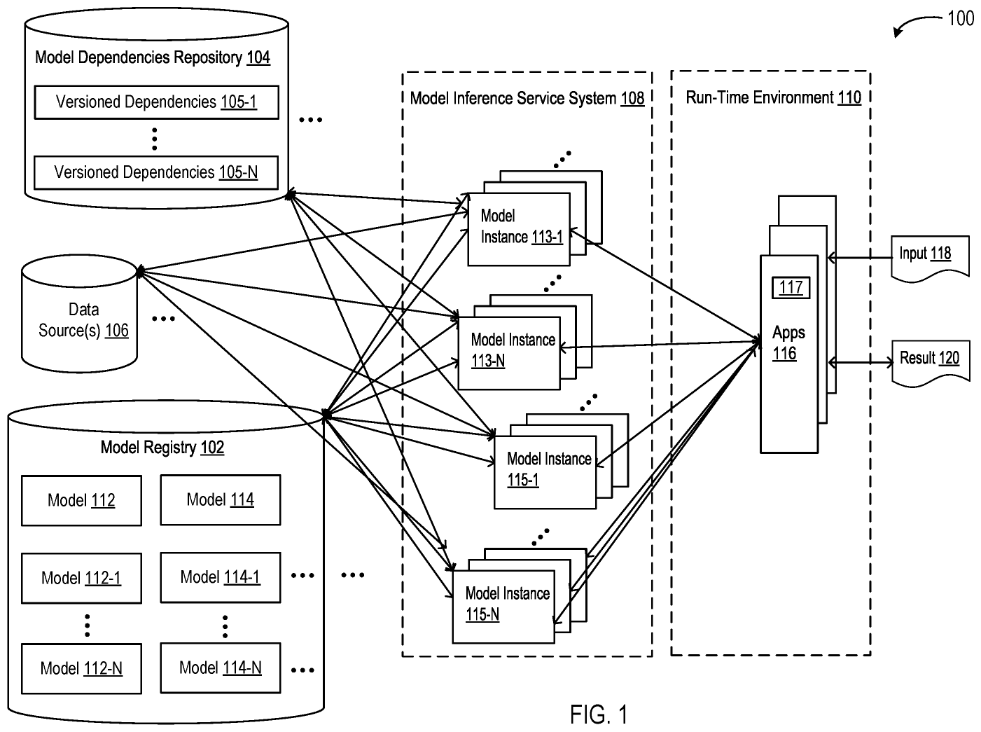

FIG. 1 depicts a diagram 100 of an example model inference service system with a model inference service and run-time environment according to some embodiments. FIG. 1 includes a model registry 102, a model dependency repository 104, data sources 106, a model inference service system 108, and a run-time environment 110. The model registry 102 includes a hierarchal structure of models 112 and 114 and model records (e.g., 112-1, 112-2, 112-N, or 114-1, 114-2, 114-N, etc.) for model versions. The model registry can 102 include a catalogue of baseline models for different domains, applications, use cases, etc. Model versions of a baseline model are the combination of one or more model records (e.g., 112-1, 112-2, 112-N, or 114-1, 114-2, 114-N, etc.) with the respective baseline model 112, 114. Model records in the hierarchical structure include changes or differences for versioning of the baseline model 112 or 114. One or more model records 112-1 . . . 112-N can be stored to capture changes to the baseline model for specific domain, application configuration, user, computing environment, data, context, use-case, etc. The model inference service utilizes metadata to store changes to the baseline model 112 as model records (e.g., 112-1, 112-2, 112-N, or 114-1, 114-2, 114-N, etc.). Model records can include intermediate representations that trace changes during a prior instantiation of the parent model record. In some implementation model records include configuration instructions to reassemble a version of the model.

For example, a baseline model 114 pre-trained on industry data can be further trained and/or fine-tuned on an organization's proprietary datasets (e.g., for example, a baseline model 114 pre-trained on industry data can be further trained and/or fine-tuned on an organization's proprietary datasets (e.g., enterprise data in datasets stored in data sources 106), and then one or more model records 114-4, 114-5 are stored with metadata that capture the changes. The one or more model records 114-4, 114-5 are stored with metadata for the captured changes. The baseline model 114 can continue to be used without the one or more model records 114-4, 114-5. The one or more model records 114-4, 114-5 can be re-assembled with the baseline model 114 for subsequent instantiations. Instantiation of a version of a model includes combining a baseline model with one or more model records and dependencies required to execute a model in a computing environment.

A catalogue of baseline models can include models for different domains or industries that are utilized by an artificial intelligent application that predict manufacturing production, recommends operational optimizations, provides insights on organizational performance, etc. Domain-specific models, model versions, model dependencies, datasets can be directed to specific application, user, computing environment, data, context, and/or use-case. For example, domain-specific datasets can also include user manuals, application data, artificial intelligence insights, and/or other types of data. Accordingly, each instantiated model version can be configured to be particularly suited to or compatible for a specific application, user, computing environment and/or use-case, which can be captured in metadata maintained with the model registry or accessible by the model inference service system. As used herein, metadata and parameters refer to static or dynamic data that the methods and systems leverage to interpret instructions or context from different sources, modules, or stages including application metadata, requestor metadata, model metadata, version metadata, dependency metadata, hardware metadata, instance metadata, etc. Model metadata can indicate configuration parameters for model instantiation, runtime, hardware, or the like. Dependency metadata indicating the required dependencies to execute model in the run-time environment and model version may be particularly suited to a specific computing environment and/or use-case. The model inference service system curates and analyzes different metadata individually and in combination to instantiate a versioned model assembled with at least a based model, model dependencies, source data for a runtime environment with execution of an application.

The model dependency repository 104 stores versioned dependencies 105-1 to 105-N (collectively, the versioned dependencies 105, and individually, the version dependency 105). The versioned dependencies 105 can include the programs, code, libraries, and/or other dependencies that are required to execute a model or set of models in a computing environment. The versioned dependencies 105 may also include links to such dependencies. In one example, the versioned dependencies 105 include the open-source libraries (or links to the open-source) required to execute models (e.g., via applications 116 that include models, such as model 112-1, 114, etc., provided by the model registry 102). The versioned dependencies 105 may be “fixed” or “frozen” to ensure consistent execution of the various models regardless of whether the required dependencies are altered (e.g., by the author of an open-source library). For example, the model inference service system 108 may obtain a model 112 from the model registry 102, obtain the required versioned dependencies (e.g., based on the particular application 116 using the model 112, the available computing resources, etc.), and generate the corresponding model instance(s) (e.g., model instance 113-1 to 113-N and/or 115-1 to 115-N) based on the model 112 and the required versioned dependencies 105. The versioned dependencies 105 can include dependency metadata. The dependency metadata can include a description of the dependencies required to execute a model in a computing environment. For example, the versioned dependencies 105 may include dependency metadata indicating the required dependencies to execute model 112-1 in the run-time environment 110.

The data sources 106 may include various systems, datastores, repositories, and the like. The data sources may comprise enterprise data sources and/or external data sources. The data sources 106 can function to store data records (e.g., storing datasets). As used herein, data records can include unstructured data records (e.g., documents and text data that is stored on a file system in a format such as PDF, DOCX, .MD, HTML, TXT, PPTX, image files, audio files, video files, application outputs, tables, code, and the like), structured data records (e.g., database tables or other data records stored according to a data model or type system), timeseries data records (e.g., sensor data, artificial intelligence application insights), and/or other types of data records (e.g., access control lists). The data records may include domain-specific datasets, enterprise datasets, and/or external datasets.

Time series refers to a list of data points in time order that can represent the change in value over time of data relevant to a particular problem, such as inventory levels, equipment temperature, financial values, or customer transactions. Time series provide the historical information that can be analyzed by generative and machine-learning algorithms to generate and test predictive models. Example implementations apply cleansing, normalization, aggregation, and combination, time series data to represent the state of a process over time to identify patterns and correlations that can be used to create and evaluate predictions that can be applied to future behavior.

In the example operation depicted in FIG. 1, the application(s) 116 receives input(s) 118. The application(s) 116 can be artificial intelligence applications and the input(s) 118 can be a command, instruction, query, and the like. For example, a user may input a question (e.g., “What is the likely downtime for the enterprise network?”) and one of the applications 116 may call one or more model instances 113-1 to 113-N and/or 115-1 to 115-N to process the query. The one or more model instances 113-1 to 113-N and/or 115-1 to 115-N is associated with the application 116 and/or are otherwise called via the application 116. The application 116 can receive output(s) from the model instance(s) and provide result(s) 120 (e.g., the model output or summary of the model output) to the user. The model inference service system 108 can automatically scale the number of model instances 113, 115 to ensure low latency (e.g., less than Is model processing time) without wasting computing resources. For example, the model inference service system 108 can automatically execute additional instances and/or terminate executing instances as needed.

The model inference service system 108 can also intelligently manage the number of executing models when the current or predicted demand for the model changes. The model inference service system 108 can automatically increase the number of executing models to meet a current or predicted demand for the model, which can allow the systems to consistently process requests at low latency. In response to the volume of requests increasing above a threshold amount, or if model request latency increases above a threshold amount, and/or if computational utilization (e.g., memory utilization) increases above a threshold amount, then the model inference service system 108 can automatically trigger various model load-balancing operations, such as deploying and executing additional instances of the model on other GPUs, executing model instances on different hardware (e.g., one or more other GPUs with more memory or other computing resources), and the like.

The model inference service system 108 can also automatically decrease the number of executing models when the current or predicted demand for the model decreases, which can allow the model inference service system 108 to free-up computing resources and minimize computational waste. In response to the volume of requests decreases below the threshold amount, or if the model request latency decreases below the threshold amount, and/or if the computational utilization decreases below the threshold amount, then the model inference service system 108 can automatically trigger other model load-balancing operations, such as terminating execution of model instances, executing models on different hardware (e.g., fewer GPUs and/or systems with GPUs with less memory or other computing resources), and the like.

The model inference service system 108 can manage (e.g., create, read, update, delete) and/or otherwise utilize profiles. Profiles can include deployment profiles and user profiles. Deployment profiles can include computing resource requirements and for executing instances of models. Computing resource requirements can include hardware requirements, such as central processing unit (CPU) requirements (e.g., number of CPUs, number of CPU cores, CPU speed etc.), GPU requirements (e.g., number of GPUs, number of GPU cores, GPU speed etc.), memory requirements (e.g., random access memory (RAM), cache, CPU memory, GPU memory, and/or other types of system memory), and the like. User profiles can include user organization, user access control information, user privileges (e.g., access to improved model response times), and the like.

In one example, the model 112 may have a template set of computing resource requirements (e.g., as indicated in model metadata). The template set of computing resource requirements may indicate a minimum number of processors, minimum number of GPUs, minimum amount of memory, and/or other hardware requirements. The model inference service system 108 may select a template deployment profile based on the template set of computing requirements and generate a deployment profile for a specific instance of the model 112 (e.g., model instance 113-1). More specifically, the model inference service system 112 can generate the deployment profile based on the template deployment profile, one or more user profiles (e.g., the user providing the input 118 and/or receiving the result 120), and run-time environment (e.g., run-time environment 110) and/or application 116 characteristics. Run-time environment characteristics can include operation system information, hardware information, and the like. Application characteristics can include the type of application, the version of the application, the application name, and the like.

The model inference service system may determine a run-time set of computing requirements for executing the model instance 113-1 based on the template set of computing requirements, the user profile, and the run-time environment and application characteristics. For example, the template hardware requirements may be increased in the deployment profile if the user profile indicates that the user has higher privileges (e.g., improved model latency requirements) or decreased in the deployment profile if the user profile indicates lower privileges (e.g., reduced model latency requirements) deployment profile for the model instance 113-1. In some embodiments, profiles can be generated by the model inference service system (e.g., pre-deployment, during deployment, run-time, after run-time, etc.) from template profiles. Template profiles can include template deployment profiles and template user profiles. The model inference service system 108 may use deployment profiles to select appropriate computing systems to execute model instances. For example, the model inference service system 108 may select a computing system not only to ensure that the computing has the minimum hardware required to execute the model instance 113-1, but also that it satisfies the user's privilege information and accounts from the run-time environment and application characteristics.

In some embodiments, the model inference service system 108 can work with enterprise generative artificial intelligence architecture that has an orchestrator agent 117 (or, simply, orchestrator 117) that supervises, controls, and/or otherwise administrates many different agents and tools. Orchestrators 117 can include one or more machine learning models and can execute supervisory functions, such as routing inputs (e.g., queries, instruction sets, natural language inputs or other human-readable inputs, machine-readable inputs) to specific agents to accomplish a set of prescribed tasks (e.g., retrieval requests prescribed by the orchestrator to answer a query). Orchestrator 117 is part of an enterprise generative artificial intelligence framework for applications to implement machine learning models such as multimodal models, large language models (LLMs), and other machine learning models with enterprise grade integrity including access control, traceability, anti-hallucination, and data-leakage protections. Machine learning models can include some or all of the different types or modalities of models described herein (e.g., multimodal machine learning models, large language models, data models, statistical models, audio models, visual models, audiovisual models, etc.). Traceable functions enable the ability to trace back to source documents and data for every insight that is generated. Data protections elements protect data (e.g., confidential information) from being leaked or contaminate inherit model knowledge. The enterprise generative artificial intelligence framework provides a variety of features that specifically address the requirements and challenges posed by enterprise systems and environments. The applications in the enterprise generative artificial intelligence framework can securely, efficiently, and accurately use generative artificial intelligence methodologies, algorithms, and multimodal models (e.g., large language models and other machine learning models) to provide deterministic responses (e.g., in response to a natural language query and/or other instruction set) that leverage enterprise data across different data domains, data sources, and applications. Data can be stored and/or accessed separately and distinctly from the generative artificial intelligence models. Execution of applications in the enterprise generative artificial intelligence framework prevent large language models of the generative artificial intelligence system from being trained using enterprise data, or portions thereof (e.g., sensitive enterprise data). This provides deterministic responses without hallucination or information leakage. The framework is adaptable and compatible with different large language models, machine-learning algorithms, and tools.

Agents can include one or more multimodal models (e.g., large language models) to accomplish the prescribed tasks using a variety of different tools. Different agents can use various tools to execute and process unstructured data retrieval requests, structured data retrieval requests, API calls (e.g., for accessing artificial intelligence application insights), and the like. Tools can include one or more specific functions and/or machine learning models to accomplish a given task (or set of tasks). Agents can adapt to perform differently based on contexts. A context may relate to a particular domain (e.g., industry) and an agent may employ a particular model (e.g., large language model, other machine learning model, and/or data model) that has been trained on industry-specific datasets, such as healthcare datasets. The particular agent can use a healthcare model when receiving inputs associated with a healthcare environment and can also easily and efficiently adapt to use a different model based on different inputs or context. Indeed, some or all of the models described herein may be trained for specific domains in addition to, or instead of, more general purposes. The enterprise generative artificial intelligence architecture leverages domain specific models to produce accurate context specific retrieval and insights.

In an example embodiment, an information retrieving agent may instruct multiple data retriever agent to receive different types of data records. For example, a structured data retriever agent can retrieve structured data records, a type system retriever agent can obtain one or more data models (or subsets of data models) and/or types from a type system. The type system provides compatibility across different data formats, protocols, operating languages, disparate systems, etc. Types can encapsulate data formats for some or all of the different types or modalities described herein (e.g., multimodal, text, coded, language, statistical, audio, visual, audiovisual, etc.). For example, a data model may include a variety of different types (e.g., in a tree or graph structure), and each of the types may describe data fields, operations, functions, and the like. Each type can represent a different object (e.g., a real-world object, such as a machine or sensor in a factory) or system (e.g., computing cluster, enterprise data stores, file systems), and each type can include a large language model context that provides context for the large language model to design or update a plan. For example, the context may include a natural language summary or description of the type (e.g., a description of the represented object, relationships with other types or objects, associated methods and functions, and the like). Types can be defined in a natural language format for efficient processing by large language models. The type system retriever agent may traverse the data model to retrieve a subset of the data model and/or types of the data model.

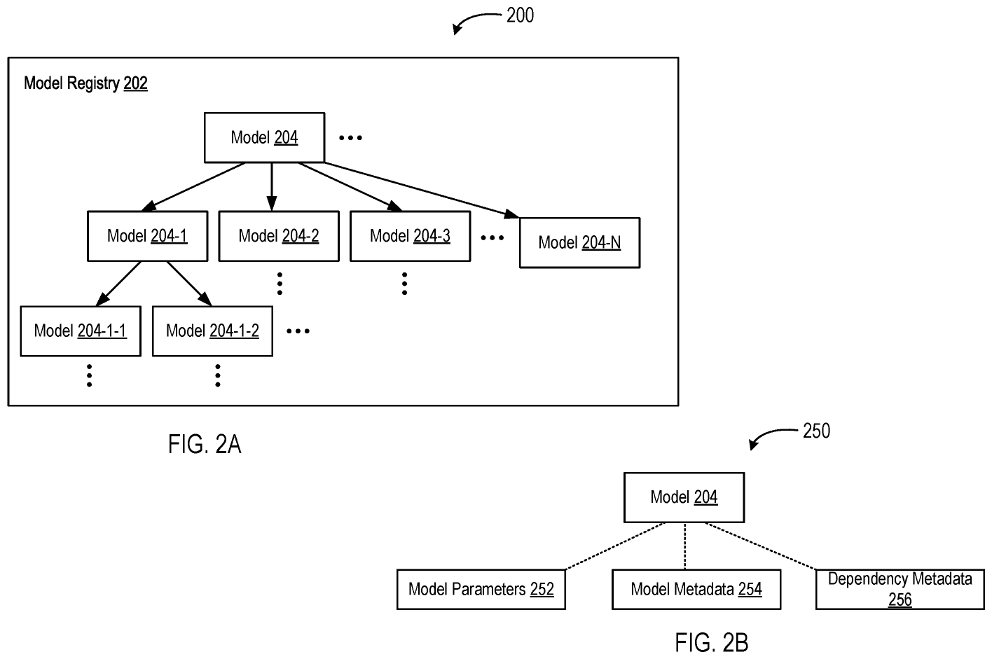

FIGS. 2A-B depict diagrams of an example structure of a model registry 202 according to some embodiments. The model registry 202 may be same as the model registry 102. In the example of FIGS. 2A-B, the model registry 202 stores models in a hierarchal structure. The top level of the structure includes nodes for each baseline model (e.g., baseline model 204), and subsequent layers include model records for subsequent versions of that baseline model. For example, a second level of the model registry 202 includes model record 204-1, 204-2, that create branched versions of the baseline model 204 and so on. Each of model record or branch of model records can be captured for different training of the baseline model 204 with different datasets. For example, the model record 204-1 may be the changes to the baseline model 204 that is further trained on a general healthcare datas4et, model record 204-2 may be the baseline model further trained on defense data, the model record 204-3 may be the baseline model further trained on an enterprise-specific dataset, and so forth. Each of those model records can also have any number children model records capturing additional versions. For example, model 204-1-1 may be the baseline model further trained on a general healthcare dataset and an enterprise-specific dataset, the model record 204-1-2 may be the changes to baseline model 204 further trained on the general healthcare dataset and a specialized healthcare dataset, and so on. Model record 204-1-2 may assembled with one or more parent model records 204-1-1 in the branch of the hierarchical model registry and the baseline model in order to instantiate a version of the model.

The “model records” stored in the model registry 202 can include model parameters (e.g., weights, biases), model metadata, and/or dependency metadata. Weights can include numerical values, such as statistical values. As used herein, a model can refer to an executable program with many different parameters (e.g., weights and/or biases). For example, a model can be an executable program generated using one or more machine learning algorithms and the model can have billions of weights. Accordingly, the model registry 202 may store executable programs. As used herein, a model (e.g., a model stored in a model registry) may also refer to model parameters without the associated code (e.g., executable code). Accordingly, the model registry 202 may store the model parameters without storing any code for executing the model. Models that do not include code may also be referred to as model configuration records.

FIG. 2B depicts an example structure of the model 204 according to some embodiments. In the example of FIG. 2B, the model 204 includes model parameters 252, model metadata 254, and dependency metadata 256. Notably, the model 204 in FIG. 2B does not include the code of the model. Accordingly, the model 204 may be referred to as a model configuration record. However, the model registry 202 may also include models that store the code in addition to the model parameters, model metadata, and/or dependency metadata. Some embodiments may also not include the dependency metadata in the model registry 202. For example, the dependency metadata may be stored in a model dependency repository or other datastore.

Returning to FIG. 2A, the subsequent model versions (e.g., 204-1) of a baseline model (e.g., baseline model 204) may only include the changes between the between the baseline model and/or any intervening versions of the baseline model. For example, baseline model 204 may include all of the information of the model 204-1, while the model version 204-1 may include a subset of information (e.g., the parameters that have changed). Similarly, the model 204-1-2 may only include the information that changed relative to the model 204-1-1. It will be appreciated that the model registry 202 can include any number of baseline models and any number of subsequent versions the baseline models.

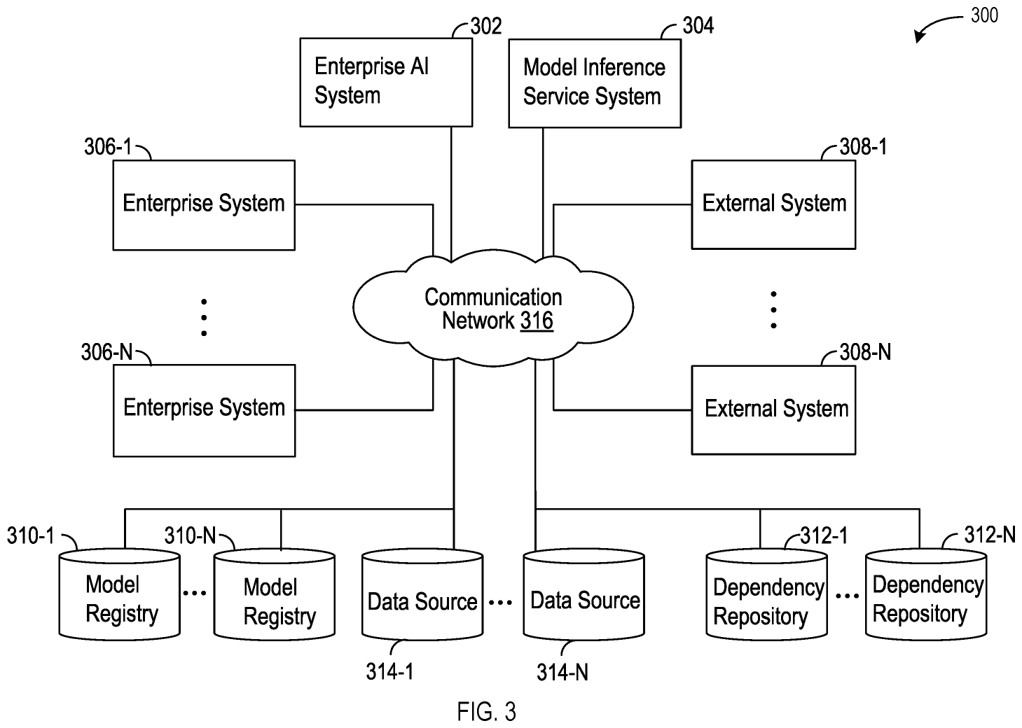

FIG. 3 depicts a diagram 300 of an example network system for machine learning model administration and optimization using a model inference service system according to some embodiments. In the example of FIG. 3, the network system includes a model inference service system 304, an enterprise artificial intelligence system 302, enterprise systems 306-1 to 306-N (individually, the enterprise system 306, collectively, the enterprise systems 306), external systems 308-1 to 308-N (individually, the external system 308, collectively, the external systems 308), model registries 310-1 to 310-N (individually, the model registries 310, collectively, the model registries 310), dependency repositories 312-1 to 312-N (individually, the model dependency repository 312, collectively, the dependency repositories 312), data sources 314-1 to 314-N (individually, the data source 314, collectively, the data sources 314), and a communication network 316.

The enterprise artificial intelligence system 302 may function to iteratively and non-iteratively generate machine learning model inputs and outputs to determine a final output (e.g., “answer” or “result”) in response to an initial input (e.g., provided by a user or another system). In some embodiments, functionality of the enterprise artificial intelligence system 302 may be performed by one or more servers (e.g., a cloud-based server) and/or other computing devices. The enterprise artificial intelligence system 302 may be implemented using a type system and/or model-driven architecture.

In some embodiments, the type system provides compatibility across different data formats, protocols, operating languages, disparate systems, etc. Types can encapsulate data formats for some or all of the different types or modalities described herein (e.g., multimodal, text, coded, language, statistical, audio, visual, audiovisual, etc.). For example, a data model may include a variety of different types (e.g., in a tree or graph structure), and each of the types may describe data fields, operations, functions, and the like. Each type can represent a different object (e.g., a real-world object, such as a machine or sensor in a factory) or system (e.g., computing cluster, enterprise datastores, file systems), and each type can include a large language model context that provides context for the large language model to design or update a plan. For example, the context may include a natural language summary or description of the type (e.g., a description of the represented object, relationships with other types or objects, associated methods and functions, and the like). Types can be defined in a natural language format for efficient processing by various models (e.g., multimodal models, large language models). A data handler module (e.g., data handler module 414) may traverse the data model to retrieve a subset of the data model and/or types of the data model. That retrieved information may be used to efficiently retrieve structured data from a structured data source (e.g., a structured data source that is structured or modeled according to the data model).

In various implementations, the enterprise artificial intelligence system 302 can provide a variety of different technical features, such as effectively handling and generating complex natural language inputs and outputs, generating synthetic data (e.g., supplementing customer data obtained during an onboarding process, or otherwise filling data gaps), generating source code (e.g., application development), generating applications (e.g., artificial intelligence applications), providing cross-domain functionality, as well as a myriad of other technical features that are not provided by traditional systems. As used herein, synthetic data can refer to content generated on-the-fly (e.g., by multimodal models) as part of the processes described herein. Synthetic data can also include non-retrieved ephemeral content (e.g., temporary data that does not subsist in a database), as well as combinations of retrieved information, queried information, model outputs, and/or the like.

The enterprise artificial intelligence system 302 can provide and/or enable an intuitive non-complex interface to rapidly execute complex user requests with improved access, privacy, and security enforcement. The enterprise artificial intelligence system 302 can include a human computer interface for receiving natural language queries and presenting relevant information with predictive analysis from the enterprise information environment in response to the queries. For example, the enterprise artificial intelligence system 302 can understand the language, intent, and/or context of a user natural language query. The enterprise artificial intelligence system 302 can execute the user natural language query to discern relevant information from an enterprise information environment to present to the human computer interface (e.g., in the form of an “answer”).

Generative artificial intelligence models (e.g., multimodal model or large language models of an orchestrator) of the enterprise artificial intelligence system 302 can interact with agents (e.g., retrieval agents, retriever agents) to retrieve and process information from various data sources. For example, data sources can store data records and/or segments of data records which may be identified by the enterprise artificial intelligence system 302 based on embedding values (e.g., vector values associated with data records and/or segments). Data records can include tables, text, images, audio, video, code, application outputs (e.g., predictive analysis and/or other insights generated by artificial intelligence applications), and/or the like.

The enterprise artificial intelligence system 302 can generate context-based synthetic output based on retrieved information from one or more retriever models. The contextual information may include access controls. In some implementations, contextual information provides user-based access controls. More specifically, the contextual information can indicate user roles that may access a corresponding segment and/or data record, and/or user roles that may not access a corresponding segment and/or data record. The contextual information may be stored in headers of the data records and/or data record segments. For example, retriever models (e.g., retriever models or a retrieval agent) can provide additional retrieved information to the multimodal models to generate additional context-based synthetic output until context validation criteria is satisfied. Once the validation criteria are satisfied, the enterprise artificial intelligence system 302 can output the additional context-based synthetic output as a result or instruction set (collectively, “answers”).

In an example implementation, model inference service system connects to one or more virtual metadata repositories across data stores, abstracts access to disparate data sources, and supports granular data access controls is maintained by the enterprise artificial intelligence system. The enterprise generative artificial intelligence framework can manage a virtual data lake with an enterprise catalogue that connect to a multiple data domains and industry specific domains. The orchestrator of the enterprise generative artificial intelligence framework is able to create embeddings for multiple data types across multiple industry verticals and knowledge domains, and even specific enterprise knowledge. Embedding of objects in data domains of the enterprise information system enable rapid identification and complex processing with relevance scoring as well as additional functionality to enforce access, privacy, and security protocols. In some implementations, the orchestrator module can employ a variety of embedding methodologies and techniques understood by one of ordinary skill in the art. In an example implementation, the orchestrator module can use a model driven architecture for the conceptual representation of enterprise and external data sets and optional data virtualization. For example, a model driven architecture can be as described in U.S. patent Ser. No. 10/817,530 issued Oct. 27, 2020, Ser. No. 15/028,340 with priority to Jan. 23, 2015 titled Systems, Methods, and Devices for an Enterprise Internet-of-Things Application Development Platform by C3 AI, Inc. A type system of a model driven architecture can used to embed objects of the data domains.

The model driven architecture handles compatibility for system objects (e.g., components, functionality, data, etc.) that can be used by the orchestrator to dynamically generate queries for conducting searches across a wide range of data domains (e.g., documents, tabular data, insights derived from AI applications, web content, or other data sources). The type system provides data accessibility, compatibility and operability with disparate systems and data. Specifically, the type system solves data operability across diversity of programming languages, inconsistent data structures, and incompatible software application programming interfaces. Type system provides data abstraction that defines extensible type models that enables new properties, relationships and functions to be added dynamically without requiring costly development cycles. The type system can be used as a domain-specific language (DSL) within a platform used by developers, applications, or UIs to access data. The type system provides interact ability with data to perform processing, predictions, or analytics based on one or more type or function definitions within the type system. The orchestrator is a mechanism for implementing search functionality across a wide variety of data domains relative to existing query modules, which are typically limited with respect to their searchable data domains (e.g., web query modules are limited to web content, file system query modules are limited to searches of file system, and so on).

Type definitions can be a canonical type declared in metadata using syntax similar to that used by types persisted in the relational or NoSQL data store. A canonical model in the type system is a model that is application agnostic (i.e., application independent), enabling all applications to communicate with each other in a common format. Unlike a standard type, canonical types are comprised of two parts, the canonical type definition and one or more transformation types. The canonical type definition defines the interface used for integration and the transformation type is responsible for transforming the canonical type to a corresponding type. Using the transformation types, the integration layer may transform a canonical type to the appropriate type.

In various embodiments, the enterprise artificial intelligence system 302 provides transformative context-based intelligent generative results. For example, the enterprise artificial intelligence system 302 can process inputs from enterprise users using a natural language interface to rapidly locate, retrieve, and present relevant data across the entire corpus of an enterprise's information systems.

The enterprise artificial intelligence system 302 can handle both machine-readable inputs (e.g., compiled code, structured data, and/or other types of formats that can be processed by a computer) and human-readable inputs. Inputs can also include complex inputs, such as inputs including “and,” “or”, inputs that include different types of information to satisfy the input (e.g., data records, text documents, database tables, and artificial intelligence insights), and/or the like. In one example, a complex input may be “How many different engineers has John Doe worked with within his engineering department?” This may require the enterprise artificial intelligence system 302 to identify John Doe in a first iteration, identify John Doe's department in a second iteration, determine the engineers in that department in a third iteration, then determine in a fourth iteration which of those engineers John Doe has interacted with, and then finally combine those results, or portions thereof, to generate the final answer to the query. More specifically, the enterprise artificial intelligence system 302 can use portions of the results of each iteration to generate contextual information (or, simply, context) which can then inform the subsequent iterations.

The enterprise generative artificial intelligence system 302 may include model processing systems that function to execute models and/or applications (or, “apps”). For example, model processing systems may include system memory, one or more central processing units (CPUs), model processing unit(s) (e.g., GPUs), and the like. The model inference service system 304 may cooperate with the enterprise artificial intelligence system 302 to provide the functionality of the model inference service system 304 to the enterprise artificial intelligence system 302. For example, the model inference service system 304 can perform model load-balancing operations on models (e.g., generative artificial intelligence models of the enterprise artificial intelligence system 302), as well other functionality described herein (e.g., swapping, compression, and the like). The model inference service system 304 may be the same as the model inference service system 108.

The enterprise systems 306 can include enterprise applications (e.g., artificial intelligence applications), enterprise datastores, client systems, and/or other systems of an enterprise information environment. As used herein, an enterprise information environment can include one or more networks (e.g., cloud, on premise or air-gapped or otherwise) of enterprise systems (e.g., enterprise applications, enterprise datastores), client systems (e.g., computing systems for access enterprise systems). The enterprise systems 306 can include disparate computing systems, applications, and/or datastores, along with enterprise-specific requirements and/or features. For example, enterprise systems 306 can include access and privacy controls. For example, a private network of an organization may comprise an enterprise information environment that includes various enterprise systems 306. Enterprise systems 306 can include, for example, CRM systems, EAM systems, ERP systems, FP&A systems, HRM systems, and SCADA systems. Enterprise systems 306 can include or leverage artificial intelligence applications and artificial intelligence applications may leverage enterprise systems and data. Enterprise systems 306 can include data flow and management of different processes (e.g., of one or more organizations) and can provide access to systems and users of the enterprise while preventing access from other systems and/or users. It will be appreciated that, in some embodiments, references to enterprise information environments can also include enterprise systems, and references to enterprise systems can also include enterprise information environments. In various embodiments, functionality of the enterprise systems 306 may be performed by one or more servers (e.g., a cloud-based server) and/or other computing devices.

In some embodiments, the enterprise systems 306 may function to receive inputs (e.g., from users and/or systems), generate and provide outputs (e.g., to users and/or systems), execute applications (e.g., artificial intelligence applications), display information (e.g., model execution results and/or outputs based on model execution results), and/or otherwise communicate and interact with the model inference service system 304, external systems 308, model registries 310, and/or dependency repositories 312. The outputs may include a natural language summary customized based on a viewpoint using the user profile. The applications can use the outputs to generate visualization such as three dimensional (3D) with interactive elements related to the deterministic output. For example, the application can use outputs to enable executing instructions (e.g., transmissions, control system commands, etc.), drilling into traceability, activating application features, and the like.

The external systems 308 can include applications, datastores, and systems that are external to the enterprise information environment. In one example, the enterprise systems 306 may be a part of an enterprise information environment of an organization that cannot be accessed by users or systems outside that enterprise information environment and/or organization. Accordingly, the example external systems 308 may include Internet-based systems, such as news media systems, social media systems, and/or the like, that are outside the enterprise information environment. In various embodiments, functionality of the external systems 308 may be performed by one or more servers (e.g., a cloud-based server) and/or other computing devices. The model registries 310 may be the same as the model registries 102 and/or other model registries described herein. The model dependency repositories 312 may be the same as the model dependency repositories 104 and/or other model dependency repositories described herein.

The dependency repositories 312 may be the same as the model dependency repositories 104 and/or other dependency repositories. For example, the dependency repositories 312 may store versioned dependencies which can include the programs, code, libraries, and/or other dependencies that are required to execute a model or set of models in a computing environment. The versioned dependencies may also include links to such dependencies. In one example, the versioned dependencies include the open-source libraries (or links to the open-source) required to execute models in a run-time environment. The versioned dependencies may be “fixed” or “frozen” to ensure consistent execution of the various models regardless of whether the required dependencies are altered (e.g., by the author of an open-source library). The versioned dependencies can include dependency metadata. The dependency metadata can include a description of the dependencies required to execute a model in a computing environment. For example, the versioned dependencies 105 may include dependency metadata indicating the required dependencies to execute models in a run-time environment.

The data sources 314 may be the same as the data sources 106. For example, the data sources 314 may include various systems, datastores, repositories, and the like. The data sources 314 may comprise enterprise data sources and/or external data sources. The data sources 314 can function to store data records (e.g., storing datasets). The data records may include domain-specific datasets, enterprise datasets, and/or external datasets. The communications network 316 may represent one or more computer networks (e.g., LAN, WAN, air-gapped network, cloud-based network, and/or the like) or other transmission mediums. In some embodiments, the communication network 316 may provide communication between the systems, modules, engines, generators, layers, agents, tools, orchestrators, datastores, and/or other components described herein. In some embodiments, the communication network 316 includes one or more computing devices, routers, cables, buses, and/or other network topologies (e.g., mesh, and the like). In some embodiments, the communication network 316 may be wired and/or wireless. In various embodiments, the communication network 316 may include local area networks (LANs), wide area networks (WANs), the Internet, and/or one or more networks that may be public, private, IP-based, non-IP based, air-gapped, and so forth.

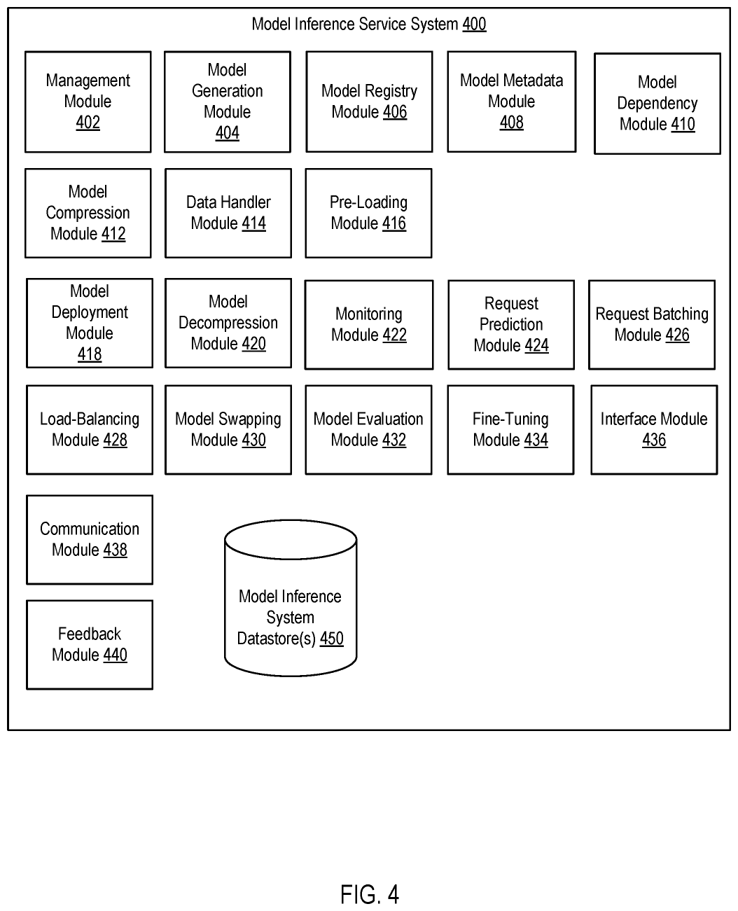

FIG. 4 depicts a diagram of an example model inference service system 400 according to some embodiments. The model inference service system 400 may be the same as model inference service system 304 and/or other model inference service systems. In the example of FIG. 4, the model inference service system 400 includes a management module 402, a model generation module 404, a model registry module 406, a model metadata module 408, a model dependency module 410, a model compression module 412, a data handler module 414, a pre-loading module 416, a model deployment module 418, a model decompression module 420, a monitoring module 422, a request prediction module 424, a request batching module 426, a load-balancing module 428, a model swapping module 430, a model evaluation module 432, a fine tuning module 434, a feedback module 440, an interface module 436, a communication module 438, and a model inference service system datastore 450.

In some embodiments, the arrangement of some or all of the modules 402-440 can correspond to different phases of a model inference service process. For example, the model generation module 404, the model registry module 406, the model metadata module 408, the model dependency module 410, the model compression module 412, the data handler module 414, and the pre-loading module 416 may correspond to a pre-deployment phase. The model deployment module 418, the model decompression module 420, the monitoring module 422, the request prediction module 424, the request batching module 426, the load-balancing module 428, the model swapping module 430, the model evaluation module 432, the fine-tuning module 434, the interface module 436, and the communication module 438 may correspond to a deployment (or, runtime) phase. The feedback module 440 may correspond to a post-deployment (or, post-runtime) phase. The management module 402 (and/or some of the other modules 402-440) may correspond to all of the phases (e.g., pre-deployment phase, deployment phase, post-deployment phase).

The management module 402 can function to manage (e.g., create, read, update, delete, or otherwise access) data associated with the model inference service system 400. The management module 402 can manage some or all of the of the datastores described herein (e.g., model inference service system datastore 450, model registries 310, dependency repositories 312) and/or in one or more other local and/or remote datastores. Registries and repositories can be a type of datastore. It will be appreciated that datastores can be a single datastore local to the model inference service system 400 and/or multiple datastores remote to the model inference service system 400. The datastores described herein can comprise one or more local and/or remote datastores. The management module 402 can perform operations manually (e.g., by a user interacting with a GUI) and/or automatically (e.g., triggered by one or more of the modules 404-428). Like other modules described herein, some or all the functionality of the management module 402 can be included in and/or cooperate with one or more other modules, services, systems, and/or datastores.

The management module 402 can manage (e.g., create, read, update, delete) profiles. Profiles can include deployment profiles and user profiles. Deployment profiles can include computing resource requirements for executing instances of models, model dependency information (e.g., model metadata), user profile information, and/or other requirements for executing a particular model or model instance. Computing resource requirements can include hardware requirements, such as central processing unit (CPU) requirements (e.g., number of CPUs, number of CPU cores, CPU speed etc.), GPU requirements (e.g., number of GPUs, number of GPU cores, GPU speed etc.), memory requirements (e.g., random access memory (RAM), cache, CPU memory, GPU memory, and/or other types of system memory), and the like. User profiles can include user organization, user access control information, user privileges (e.g., access to improved model response times), and the like.

In one example, the model may have a template set of computing resource requirements (e.g., as indicated in model metadata). The template set of computing resource requirements may indicate a minimum number of processors, minimum number of GPUs, minimum amount of memory, and/or other hardware requirements. The model inference service system 108 may select a template deployment profile based on the template set of computing requirements and generate a deployment profile for a specific instance of the model (e.g., model instance). More specifically, the model inference service system can generate the deployment profile based on the template deployment profile, one or more user profiles (e.g., the user providing the input and/or receiving the result), and run-time environment (e.g., run-time environment) and/or application characteristics. Run-time environment characteristics can include operation system information, hardware information, and the like. Application characteristics can include the type of application, the version of the application, the application name, and the like.

The model generation module 404 can function to obtain, generate, and/or modify some or all of the different types or modalities of models described herein (e.g., multimodal machine learning models, large language models, data models, statistical models, audio models, visual models, audiovisual models). In some implementations, the model generation module 404 can use a variety of machine learning techniques or algorithms to generate models. Artificial intelligence and/or machine learning can include Bayesian algorithms and/or models, deep learning algorithms and/or models (e.g., artificial neural networks, convolutional neural networks), gap analysis algorithms and/or models, supervised learning techniques and/or models, unsupervised learning algorithms and/or models, semi-supervised learning techniques and/or models random forest algorithms and/or models, similarity learning and/or distance algorithms, generative artificial intelligence algorithms and models, clustering algorithms and/or models, transformer-based algorithms and/or models, neural network transformer-based machine learning algorithms and/or models, reinforcement learning algorithms and/or models, and/or the like. The algorithms may be used to generate the corresponding models. For example, the algorithms may be executed on datasets (e.g., domain-specific data sets, enterprise datasets) to generate and/or output the corresponding models.

In some embodiments, a multimodal model is a deep learning model (e.g., generated by a deep learning algorithm) that can recognize, summarize, translate, predict, and/or generate data and other content based on knowledge gained from massive datasets. Machine-learning models (e.g., multimodal, large language, etc.) may comprise transformer-based models. For example, large language models can include Google's BERT/BARD, OpenAI's GPT, and Microsoft's Transformer. Models can process vast amounts of data, leading to improved accuracy in prediction and classification tasks. The machine-learning models can use this information to learn patterns and relationships, which can help them make improved predictions and groupings relative to other machine learning models. Machine-learning models can include artificial neural network transformers that are pre-trained using supervised and/or semi-supervised learning techniques. In some embodiments, large language models comprise deep learning models specialized in text generation. Large language models may be characterized by a significant number of parameters (e.g., in the tens or hundreds of billions of parameters) and the large corpuses of text used to train them. Parameters can include weights (e.g., statistical weights). The models may include deep learning models specifically designed to receive different types of inputs (e.g., natural language inputs and/or non-natural language inputs) to generate different types of outputs (e.g., natural language, images, video, audio, code). For example, an audio model can receive a natural language input (e.g., a natural language description of audio data) and/or audio data and provide natural language outputs (e.g., summaries) and/or other types of output (e.g., audio data).

In another example, a video model can receive a natural language input (e.g., a natural language description of video data) and/or video data and provide natural language outputs (e.g., summaries) and/or other types of output (e.g., video data). In another example, an audiovisual model can receive a natural language input (e.g., a natural language description of audiovisual data) and/or audiovisual data and provide natural language outputs (e.g., summaries) and/or other types of output (e.g., audiovisual data). In another example, a code generation model can receive a natural language input (e.g., a natural language description of computer code) and/or computer code and provide natural language outputs (e.g., summaries, human-readable computer code) and/or other types of output (e.g., machine-readable computer code).

The model generation module 404 can generate models, assemble models, retrain models, and/or fine-tune models. For example, the model generation module 404 may generate baseline models (e.g., baseline model 204), subsequent versions of models (e.g., model 204-1, 204-2, etc.) stored in model registries. The model generation module 404 can use feedback captured by the feedback module 440 to retrain and/or fine-tune models. The model generation module 404 can use the feedback as part of a reinforcement learning process to accelerate knowledge base bootstrapping. Reinforcement learning can be used for explicit bootstrapping of various systems (e.g., with instrumentation of time spent, results clicked on, and/or the like).

Reinforcement learning is a machine learning training method based on rewarding desired behaviors and/or punishing undesired ones. In general, a reinforcement learning agent is able to perceive and interpret its environment, take actions and learn through trial and error. Reinforcement learning uses algorithms and models to determine optimal behavior in an environment to obtain maximum reward. This optimal behavior is learned through interactions with the environment and observations of how to respond. Without a supervisor, the learner independently discovers sequence of actions to maximize a reward. This discovery process is like a trial-and-error search. The quality of actions can be measured by the immediate reward that is return as wells as the delayed reward that may be fetched. Actions can be learned that result in success in an environment without the assistance of a supervisor, reinforcement learning is a powerful tool. ColBERT is an example retriever model, enabling scalable BERT-based search over large text collections (e.g., in tens of milliseconds). ColBERT uses a late interaction architecture that independently encodes a query and a document using BERT and then employs a “cheap” yet powerful interaction step that models their fine-grained similarity. Beyond reducing the cost of re-ranking documents retrieved by a traditional model, ColBERT's pruning-friendly interaction mechanism enables leveraging vector-similarity indexes for end-to-end retrieval directly from a large document collection.

The model generation module 404 can train generative artificial intelligence models to develop different types of responses (e.g., best results, ranked results, smart cards, chatbot, new content generation, and/or the like). The model generation module 404 may determine a run-time set of computing requirements for executing the model instance based on the template set of computing requirements, the user profile, and the run-time environment and application characteristics. For example, the template hardware requirements may be increased in the deployment profile if the user profile indicates that the user has higher privileges (e.g., improved model latency requirements) or decreased in the deployment profile if the user profile indicates lower privileges (e.g., reduced model latency requirements) deployment profile for the model instance. In some embodiments, profiles can be generated by the model inference service system (e.g., pre-deployment, during deployment, run-time, after run-time, etc.) from template profiles. Template profiles can include template deployment profiles and template user profiles.

The model registry module 406 can function to access model registries (e.g., model registry 102) to store models in model registries, retrieve models from model registries, search model registries for particular models, and transmit models (e.g., from a model registry to a run-time environment). As used, “model” can refer to model configurations and/or executable code (e.g., an executable model). Model configurations can include model parameters of a corresponding model (e.g., parameters of billions of parameters of a large language model and/or a subset of the parameters of the parameters of a large language model). The model configurations can also include model metadata that describe various features, functions, and parameters. The model configurations may also include dependency metadata describing the dependencies of the model. For example, the dependency metadata may indicate a location of executable code of the model, run-time dependencies associated with the model, and the like. Run-time dependencies can include libraries (e.g., open-source libraries), code, and/or other requirements for executing the model in a run-time environment. Accordingly, as indicated above, reference to a model can refer to the model configurations and/or executable code (e.g., an executable model).

The models may be trained on generic datasets and/or domain-specific datasets. For example, the model registry may store different configurations of various multimodal models. The model registry module 406 can traverse different levels (or, tiers) of a hierarchical structure (e.g., tree structure, graph structure) of a model registry (e.g., as shown as described in FIG. 2). For example, the model registry module 406 can traverse the different levels to search for and/or obtain specific model versions from a model registry.

The model metadata module 408 can function to generate model metadata. The run-time dependencies can include versioned run-time dependencies which include specific versions of the various dependencies (e.g., specific version of an open-source library) required to execute a specific version of a model. The versioned dependencies may be referred to as “fixed” because the code of the versioned dependencies will not change even if libraries, code, and the like, of the dependencies are updated. For example, a specific version of a model may include model metadata specifying version 3.1 of an open-source library required to execute the specific version of the model. Even if the open-source library is updated (e.g., to version 3.2), the versioned dependency indicated in the model metadata will still be the version required to execute the specific model version (e.g., open-source library version 3.1). The model metadata is human-readable and/or machine-readable and describes or otherwise indicates the various features, functions, parameters, and/or dependencies of the model. The model metadata module 408 can generate model metadata when a model is generated and/or updated (e.g., trained, tuned).

The model dependency module 410 can function to obtain model dependencies (e.g., versioned model dependencies). For example, the model dependency module 410 may interpret dependency metadata to obtain dependencies from various dependency repositories. For example, the model dependency module 410 can automatically lookup the specific version of run-time dependencies required to execute a particular model and generate corresponding model metadata that can be stored in the model registry. Similarly, if a new version of a model is generated or otherwise obtained (e.g., because a previous version of model was trained/tuned on another dataset, such a domain-specific dataset, time series data, etc.), the model dependency module 410 can generate new dependency metadata corresponding to the new version of the model and the model registry module 406 can store the new model metadata in the model registry along with the new version of the model.

The model compression module 412 can function to compress models. More specifically, the model compression module 412 can compress parameters and/or parameters of one or more models to generate compressed models. For example, the model compression module 412 may compress model parameters a model by quantizing some or all of the parameters of the model.

The data handler module 414 can function to manage data sources, locate or traverse one or more data store (e.g., data store 106 of FIG. 1) to retrieve a subset of the data and/or types of the data. The data handler module 414 can generate synthetic data to train models as well as aggregate or anonymize data (e.g., data received via feedback module 440). The data handler module 414 can handle data source during run-time (e.g., live data stream or time series data). That retrieved information may be used to efficiently retrieve structured data from a structured data source (e.g., a structured data source that is structured or modeled according to the data model).

The pre-loading module 416 can function to provide and/or identify deployment components used when generating models (or model instances). Deployment components can include adapters and adjustment components. Adapters can include relatively small layers (e.g., relative to other layers of the model) that are stitched into models (e.g., models or model records obtained from a model registry) to configure the model for specific tasks. The adapters may also be used to configure a model for specific languages (e.g., English, French, Spanish, etc.). Adjustment components can include low-ranking parameter (e.g., weight) adjustments of the model based on specific tasks. Tasks can include generative tasks, such as conversational tasks, summarization tasks, computational tasks, predictive tasks, visualization tasks, and the like.

The model deployment module 418 can function to deploy some or all of the different types of models. For example, the model deployment module 418 may cooperate with the model swapping module 430 to swap or otherwise change models deployed on a model processing system, and/or swap or change hardware (e.g., swap model processing systems and/or model processing units) that execute the models. Swapping the models may include replacing some or all of the weights of a deployed model with weights of another model (e.g., another version of the deployed model). The model deployment module 418 can function to assemble (or provide instructions to assemble) and/or load models into memory. For example, the model deployment module 418 can assemble or generate (or provide instructions to assemble or generate) models (or model instances) based on model records stored in a model registry, model dependencies, deployment profiles, and/or deployment components. This can allow the system 400 to efficiently load models for specific tasks (e.g., based on the model version, the deployment components, etc.).

The model deployment module 418 can then load the model into memory (e.g., memory of another system that executes the model). The model deployment module 418 can load models into memory (e.g., model processing system memory and/or model processing unit memory) prior to a request or instruction for the models to be executed or moved to an executable location. For example, a model processing system may include system memory (e.g., RAM) and model processing unit memory (e.g., GPU memory). The model deployment module 418 can pre-load a model into system memory and/or model processing unit memory of a model processing system in anticipation that it will be executed within a period of time (e.g., seconds, minutes, hours, etc.). For example, the request prediction module 424 may predict a utilization of a model, and the model deployment module 418 can pre-load a particular number of instances on to one or more model processing units based on the predicted utilization. The model deployment module 418 may use deployment profiles to select appropriate computing systems to execute model instances. For example, the model deployment module 414 108 may select a computing system not only to ensure that the computing system has the minimum hardware required to execute the model instance, along with the appropriate dependencies, but also that it satisfies the user's privilege information and accounts from the run-time environment and application characteristics.

The model deployment module 418 can function to pre-load models (e.g., into memory) based on a pre-load threshold utilization condition. For example, the pre-load threshold utilization condition may indicate threshold values for any volume (e.g., number) of requests and/or a period of time the requests are predicted to be received. If a predicted utilization (e.g., a number of requests and/or a period of time the requests are predicted to be received) is satisfied (e.g., the utilization meets or exceeds the threshold values), the pre-loading module 416 may pre-load the models. More specifically, the model deployment module 414 may determine a number of model instances, model processing systems, and/or model processing units required to process the predicted model utilization. For example, the model deployment module 418 may determine that five instances of a model are required to process the anticipated utilization and that each of the five instances should be executed on a separate model processing unit (e.g., GPU). Accordingly, in this example, the model deployment module 414 can pre-load five instances of the model on five different model processing units.

The model decompression module 420 may decompress one or more compressed models (e.g., at run-time). In some implementations, the model decompression module 420 may dequantize some or all parameters of a model at runtime. For example, the model deployment module 418 may dequantize a quantized model. Decompression can include pruning, knowledge distillation, and/or matrix decomposition.

The monitoring module 422 can function to monitor system utilization (e.g., model processing system utilization, model processing unit utilization) and/or model utilization. System utilization can include hardware utilization (e.g., CPU, RAM, cache, GPU, GPU memory), system firmware utilization, system software (e.g., operating system) utilization, and the like. System utilization can also include a percentage of utilized system resources (e.g., percentage of memory, processing capacity, etc.). Model utilization can include a volume of requests received and/or processed by a model, a latency of processing model requests (e.g., 1s), and the like. The monitoring module 422 can monitor model utilization and system utilization to determine hardware performance and utilization and/or model performance and utilization to continuously determine amounts of time a system is idle, a percentage of memory being used, processing capacity being used, network bandwidth being used, and the like. The monitoring can be performed continuously and/or for a period of time.

The request prediction module 424 can function to predict the volume of requests that will be received, types of requests that will be received, and other information associated with model requests. For example, request prediction module 424 may use a machine learning model to predict that a model will receive a particular volume of requests (e.g., more than 1000) with a particular period of time (e.g., in one hour), which can allow the load-balancing module 428 to automatically scale the models accordingly.

The request batching module 426 can function to batch model requests. The request batching module 426 can perform static batching and continuous batching. In static batching, the request batching module 426 can batch multiple simultaneous requests (e.g., 10 different model requests received by users and/or systems) into a single static batch request including the multiple requests and provide that batch to one or more model processing systems, model processing units, and/or model instances, which can improve computational efficiency. For example, traditionally each request would be passed to a model individually and would require the model to be “called” or executed 10 times, which is computationally inefficient. With static batching, the model may only need to be called once to process all of the batched requests.

Continuous batching may have benefits relative to static batching. For example, in static batching nine of ten requests may be processed relatively quickly (e.g., 1 second) while the other request may require more time (e.g., 1 minute), which can result in the batch taking 1 minute to process, and the resources (e.g., model processing units) that were used to process the first nine requests would remain idle for the following 59 seconds. In continuous batching, the request batching module 426 can continuously update the batch as requests are completed and additional requests are received. For example, if the first nine requests are completed in 1 second, additional requests can be immediately added to the batch and processed by the model processing units that completed the first 9 requests. Accordingly, continuous batching can reduce idle time of model processing systems and/or model processing units and increase computational efficiency.

The load-balancing module 428 can function to automatically (e.g., without requiring user input) trigger model load-balancing operations, such as automatically scaling model executions and associated software and hardware, changing models (or instructing the model swapping module 430 to change models), and the like. For example, the load-balancing module 428 can automatically increase or decrease the number of executing models to meet a current demand (e.g., as detected by the monitoring module 422) and/or predicted demand for the model (e.g., as determined by the request prediction module 424), which can allow the model inference service system 400 to consistently ensure that requests are processed with low latency. In some embodiments, in response to the volume of requests crossing a threshold amount, or if model request latency crosses a threshold amount, and/or if computational utilization (e.g., memory utilization) crosses a threshold amount, then the load-balancing module 428 can automatically trigger various model load-balancing operations, such as deploying and executing additional instances of the model on other GPUs, terminating execution of model instances, executing model instances on different hardware (e.g., one or more other GPUs with more memory or other computing resources), and the like.

The load-balancing module 428 can trigger execution of any number of instances of any number of models on any number of systems (e.g., model processing systems, model processing units). For example, if a model is receiving a volume of requests above a threshold value, the load-balancing module 428 can automatically trigger execution of additional instances of the model and/or move models to a different system (e.g., a system with more computing resources). Conversely, the load-balancing module 428 can also terminate execution of any number of instances of any number of models on any number of systems (e.g., model processing systems, model processing units). For example, if the volume of requests is below a threshold value, the load-balancing module 428 can automatically terminate execution of one or more instances of a model, move a model from one system to another (e.g., to a system with few computing resources), and the like. The load-balancing module 428 can function to control the parallelization of the various systems, model processing units, models, and methods described herein. For example, the load-balancing module 428 may trigger parallel execution of any number of model processing systems, processing units, and/or any number of models. The load-balancing module 428 may trigger load-balancing operations based on deployment profiles. For example, if a model is not satisfying a latency requirement specified in the deployment profile, the load-balancing module 428 may trigger execution of additional instances of the model.

The model swapping module 430 can function to change models (e.g., at or during run-time in addition to before or after run-time). For example, a model may be executing a particular system or unit, and the model swapping module 430 may swap that model for a model that has been trained on a specific dataset (e.g., a domain-specific data set) because that model has been receiving requests related to that specific dataset. In some embodiments, model swapping includes swapping the parameters of a model with different parameters (e.g., parameters of a different version of the same model).

The model swapping module 430 can function to change (e.g., swap) the model processing systems and/or model processing units that are used to execute models. For example, if system utilization and/or model utilization is low (e.g., below a threshold amount), the model swapping module 430 may terminate execution of a model on one or more model processing units and trigger execution of that model on other model processing systems and/or model processing units with fewer computing resources. Similarly, if system utilization and/or model utilization is high (e.g., above a threshold amount), the model swapping module 430 may terminate execution of a model on one or more model processing units and trigger execution of that model on other model processing systems and/or model processing units with greater amounts of computing resources.

The model evaluation module 432 can function to evaluate model performance. Model performance can include system latency (e.g., responses times for processing model requests), bandwidth, system utilization, and the like. The model evaluation module 432 may evaluate models (or model instances) before run-time, at run-time, and/or after run-time. The model evaluation module 432 may evaluate models continuously, on-demand, periodically, and/or may be triggered by another module and/or trigger another module (e.g., model swapping module 430). For example, the model evaluation module 432 may evaluate a model is performing poorly (e.g., above a threshold latency requirement and/or providing unsatisfactory response, etc.) and trigger the model swapping module 430 to swap the model for a different model or different version of the model (e.g., a model that has been trained and/or fine-tuned on additional datasets).

The fine-tuning module 434 can function to fine-tune models. Fine-tuning can include adjusting the parameters (e.g., weights and/or biases) of a trained model on a new dataset or during run-time (e.g., live data stream or time series data. According, the model may already have some knowledge of the features and patterns, and it can be adapted to the new dataset more quickly and efficiently (e.g., relative to retraining). In one example, the fine-tuning module 434 can fine-tune models if a new dataset is similar to the original dataset (or intervening dataset(s)), and/or if there is not enough data available to retrain the model from scratch.

In some embodiments, the fine-tuning module 434 can fine-tune models (e.g., transformer-based natural language machine learning models) periodically, on-demand, and/or in real-time. In some example implementations, corresponding candidate models (e.g., candidate transformer-based natural language machine learning models) can be fine-tuned based on user selections and the fine-tuning module 434 can replace some or all of the models with one or more candidate models that have been fine-tuned on the user selections. In one example, the fine-tuning module 434 can use feedback captured by the feedback module 440 to fine-tune models. The fine-tuning module 434 can use the feedback as part of a reinforcement learning process to accelerate knowledge base bootstrapping.

The interface module 436 can function to receive inputs (e.g., complex inputs) from users and/or systems. The interface module 436 can also generate and/or transmit outputs. Inputs can include system inputs and user inputs. For example, inputs can include instructions sets, queries, natural language inputs or other human-readable inputs, machine-readable inputs, and/or the like. Similarly, outputs can also include system outputs and human-readable outputs. In some embodiments, an input (e.g., request, query) can be input in various natural forms for easy human interaction (e.g., basic text box interface, image processing, voice activation, and/or the like) and processed to rapidly find relevant and responsive information.

The interface module 436 can function to generate graphical user interface components (e.g., server-side graphical user interface components) that can be rendered as complete graphical user interfaces on the model inference service system 400 and/or other systems. For example, the interface module 436 can function to present an interactive graphical user interface for displaying and receiving information. The communication module 438 can function to send requests, transmit and receive communications, and/or otherwise provide communication with one or more of the systems, services, modules, registries, repositories, engines, layers, devices, datastores, and/or other components described herein. In a specific implementation, the communication module 438 may function to encrypt and decrypt communications. The communication module 438 may function to send requests to and receive data from one or more systems through a network or a portion of a network (e.g., communication network 316). In a specific implementation, the communication module 438 may send requests and receive data through a connection, all or a portion of which can be a wireless connection. The communication module 438 may request and receive messages, and/or other communications from associated systems, modules, layers, and/or the like. Communications may be stored in the model inference service system datastore 450.

The feedback module 440 can function to capture feedback regarding model performance (e.g., response time), model accuracy, system utilization (e.g., model processing system utilization, model processing unit utilization), and other attributes. For example, the feedback module 440 can track user interactions within systems, capturing explicit feedback (e.g., through a training user interface), implicit feedback, and the like. The feedback can be used to refine models (e.g., by the model generation module 404).

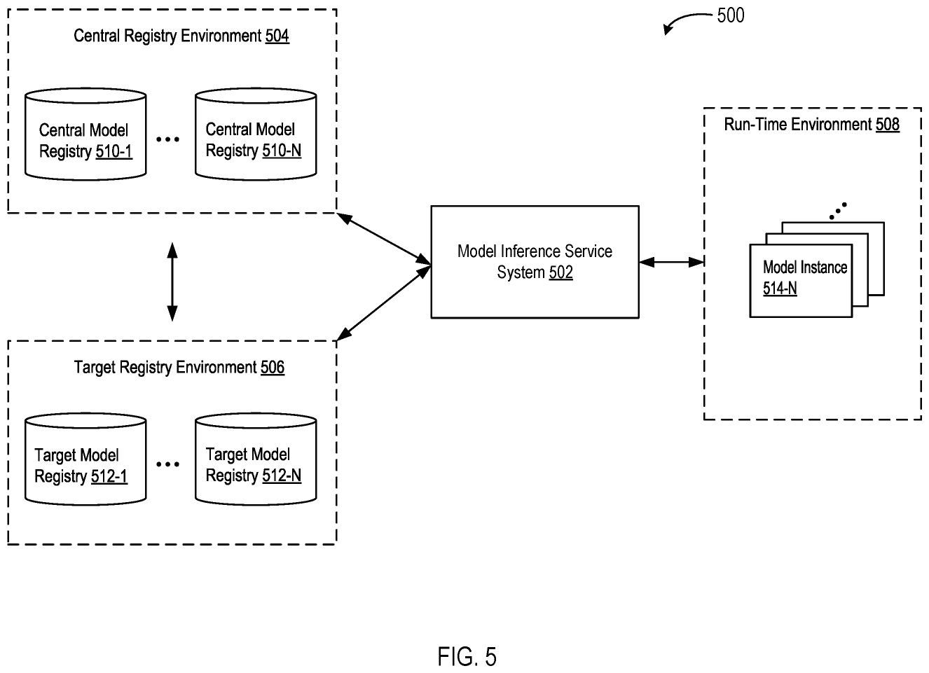

FIG. 5 depicts a diagram 500 of an example computing environment including a central model registry environment 504 and a target model registry environment 506 according to some embodiments. The central registry environment 504 can include central model registries 510. The central registry environment 504 may be an environment of a service provider (e.g., a provider of an artificial intelligence services or applications) and the central model registries 510 can include models of that service provider. The target registry environment 506 may be an environment of a client of the service provider and can include target model registries 512 and the target model registries 512 can include models of the client. For example, the central model registries 510 may store various baseline models, and the target model registries 512 may store subsequent versions of a subset of those baseline models that the have been trained using datasets of the target environment (e.g., an enterprise network of the client).

In the example of FIG. 5, the model inference service system 502 can coordinate interactions between the central registry environment 504, the target registry environment 506, and the model processing systems 508 that execute instances 514 of the models. The model inference service system 502 may be the same as the model inference service system 400 and/or other model inference service systems described herein. The model inference service system 502 can manually (e.g., in response to user input) and/or automatically (e.g., without requiring user input) obtain (e.g., pull or push) models from the central model registries 510 to the target model registries 512. The model inference service system 502 may also provide models from the target model registries 512 to the central model registries 510.

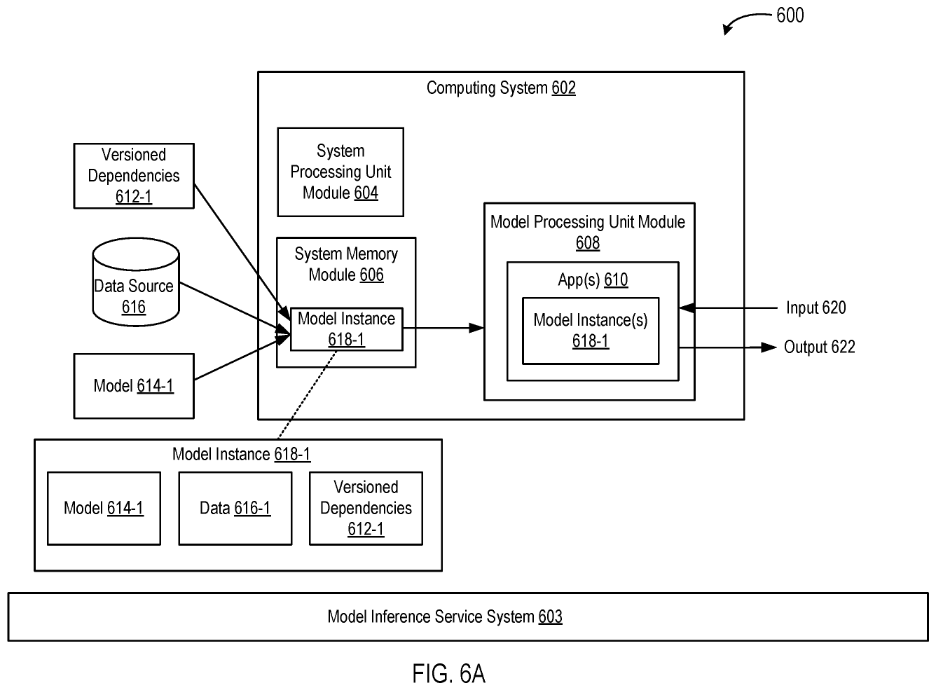

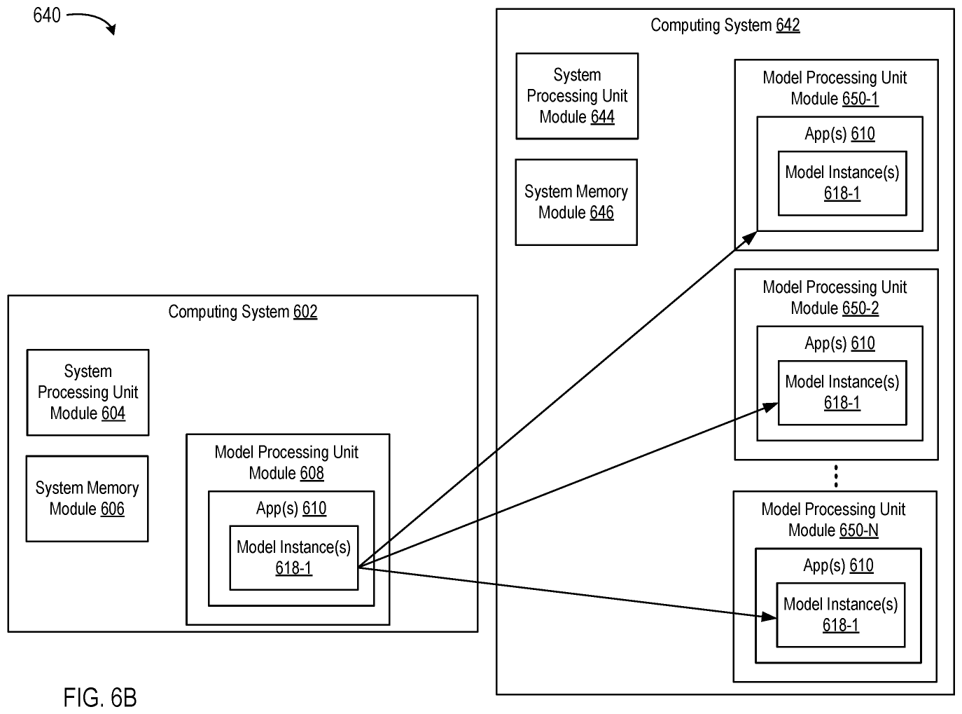

FIG. 6A depicts a diagram 600 of a computing system 602 implementing a model pre-loading process according to some embodiments. More specifically, a model inference service system 603 can provide versioned dependencies 612 (e.g., from dependency repositories) and the model 614 (e.g., from a model registry, central model registry, target model registry, etc.) to the system memory module 606 of the computing system 602. The model inference service system 603 may be the same as the model inference service system 400. In some embodiments, the model 614 may only include the model parameters that have changed relative to a previous version of the model (e.g., baseline model). The computing system 602 may generate a model instance 618 using the model 614 and/or the versioned dependencies 612. The computing system 602 may execute the model instance 618 on the model processing unit 608 to process requests (e.g., inputs 620) and generate results (e.g., outputs 622).

The model inference service system and/or computing system 602 may perform any of these steps on demand, automatically, and/or in response to anticipated or predicted model requests or utilization. For example, the model inference service system may pre-load the model 614 into the system memory module 606 and/or model processing unit module 608 in response to a prediction by the model inference service system that the model will be called within a threshold period of time (e.g., within 1 minute). The model inference service system may also predict a volume of requests and determine how many model instances and whether other model processing systems are needed. If so, the model inference service system may similarly pre-load the model on other model processing systems and/or model processing units.

The versioned dependencies 612 may be the same as the versioned dependencies 105, and the model 614 may be any of the models described herein. The computing system 602 may be a system or subsystem of the enterprise artificial intelligence system 302 and/or other model processing systems described herein. In the example of FIG. 6A, the computing system 602 includes a system processing unit module (or, simply, model processing unit) 608, a system memory module (or, simply, system memory) 606, and a model processing unit module (or, simply, model processing unit) 608. The computing system 602 may be one or more servers, computing clusters, nodes of a computing cluster, edge devices, and/or other type of computing device configured to execute models. For example, the system processing unit module 604 may be one or more CPUs and the system memory may include random access memory (RAM), cache memory, persistent storage memory (e.g., solids state memory), and the like. The model processing unit 608 may comprise one or more GPUs which can execute models or instances thereof (e.g., model instance 618-1).

FIG. 6B depicts a diagram 640 of an automatic load-balancing process according to some embodiments. In the example of FIG. 6B, the model inference service system can spin up (e.g., execute) additional model instances (e.g., model instances 618) of the model 614 on additional model processing systems 648 as needed to satisfy a current or predicted demand for the model 614.

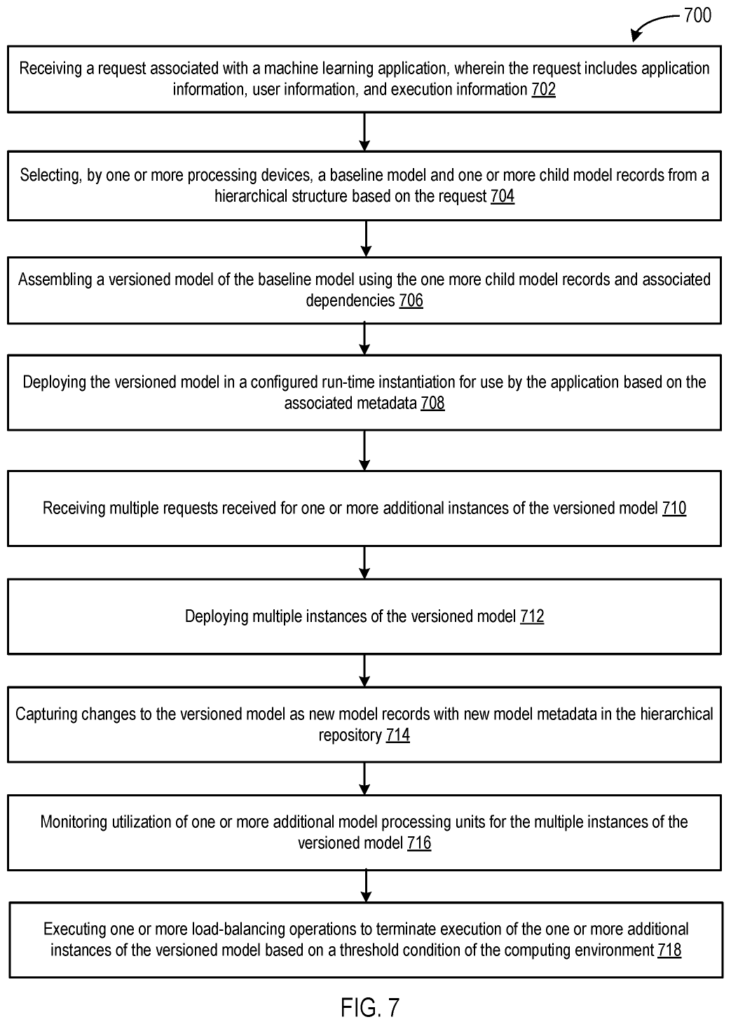

FIG. 7 depicts a flowchart 700 of an example method of model administration according to some embodiments. In this and other flowcharts and/or sequence diagrams, the flowchart illustrates by way of example a sequence of steps. In step 702, a model inference service system (e.g., model inference service system 400) receives a request associated with a machine learning application (e.g., application 116). The request includes application information, user information, and execution information. In some embodiments, a communication engine (e.g., communication module 438) receives the request. In some embodiments, the child model records may include intermediate representations of the baseline model with changed parameters from a previous instantiation of the baseline model. The child model records may include intermediate representations of the baseline model with changed parameters from a previous instantiation of the baseline model. The one or more child model records may include intermediate representations with changed parameters of the baseline model trained on an enterprise specific dataset.

In step 704, the model inference service system selects, by one or more processing devices, a baseline model (e.g., baseline model 204) and one or more child model records (e.g., child model records 204-1, 204-2. etc.) from a hierarchical structure (e.g., model registry 202) based on the request. The baseline model and the one more child model records include model metadata (e.g., model metadata 254 and/or dependency metadata 256) with parameters describing dependencies (e.g., versioned dependencies 612-1) and deployment configurations. In some embodiments, a model registry (e.g., model registry module 406) selects the baseline model the child model record(s). The deployment configurations may determine a set of computing requirements for the run-time instance of the versioned model. In some embodiments, selecting the baseline model and one or more child model records includes determining compatibility between the application information and the execution information of the request with dependencies and deployment configurations from the model metadata. Selecting the baseline model and one or more child model records may also include determining access control of the model metadata and the user information of the request.

In step 706, the model inference service system assembles a versioned model of the baseline model using the one more child model records and associated dependencies. In some embodiments, a model deployment module (e.g., model deployment module 418) assembles the versioned model. In some embodiments, assembling the versioned model further includes pre-loading a set of model configurations including model weights and/or adapter instructions (e.g., instructions to include one or more deployment components when assembling the versioned model). In step 708, the model inference service system deploys the versioned model in a configured run-time instantiation (e.g., model instance 618-1) for use by the application based on the associated metadata. In some embodiments, the model deployment module deploys the versioned model in a configured run-time instantiation. In step 710, the model inference service system receives multiple requests for one or more additional instances of the versioned model. In some embodiments, the communication module receives the request.

In step 712, the model inference service system deploys multiple instances of the versioned model. In some embodiments, the model deployment module deploys the multiple instances of the versioned model. In step 714, the model inference service system captures changes to the versioned model as new model records with new model metadata in the hierarchical repository. In some embodiments, the model generation module and/or model registry module (e.g., model registry module 406) captures the changes to the versioned model as new model records with new model metadata in the hierarchical repository. In step 716, the model inference service system monitors utilization of one or more additional model processing units for the multiple instances of the versioned model. In some embodiments, a monitoring module (e.g., monitoring module 422) monitors the utilization. In step 718, the model inference service system executes one or more load-balancing operations to terminate execution of the one or more additional instances of the versioned model based on a threshold condition of the computing environment. In some embodiments, a load-balancing module (e.g., load-balancing module 428 executes and/or triggers executes of the one or more load-balancing operations.

An example embodiment includes a system comprising: memory storing instructions that, when executed by the one or more processors, cause the system to perform: a model inference service for instantiating different versioned model to service a machine-learning application. A model registry comprises a hierarchical structure with a baselines model and child model records that include model metadata with parameters describing dependencies and deployment configurations to assemble the different versioned model. Each versioned model is assembled with the baseline model using the one more child model records and associated dependencies. The model inference service concurrently deploys multiple run-time instances with different versions of the model for different user sessions. The model registry is updated with new model records based on the changes to the baseline model from multiple run-time instances.

In some embodiments, the versioned model for each user session of the different users is based at least on the users access control privileges of each user session. The hierarchical repository comprises a catalogue of additional baseline models pretrained on datasets from different domains. The additional model records associated with each additional baseline model is fine-tuned using local enterprise datasets. The machine-learning application may utilize the versioned model, and deploying the versioned model may further include the machine learning application executing instructions to transmit control system commands for one or more industrial devices.

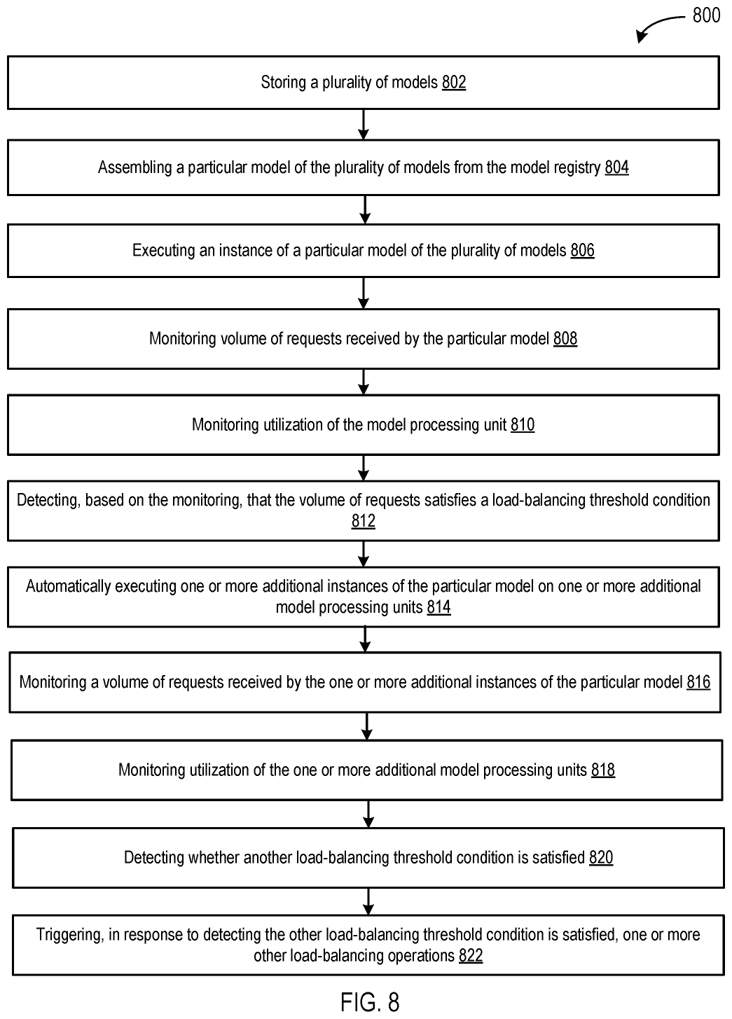

FIG. 8 depicts a flowchart 800 of an example method of model load-balancing according to some embodiments. In this and other flowcharts and/or sequence diagrams, the flowchart illustrates by way of example a sequence of steps. In step 802, a model registry (e.g., model registry 310) stores a plurality of models (e.g., models 112, 114, and the like). The models may include large language models and/or other types of modal machine learning models. In some embodiments, a model inference service system (e.g., model inference service system 304) manages the model registry and/or functions thereof. Each of the models in the model registry can include respective model parameters, model metadata, and/or dependency metadata. The model metadata can describe the model (e.g., model type, model version, training data used to train the model, and the like). The dependency metadata can indicate versioned run-time dependencies associated with the respective model (e.g., versioned dependencies required to execute the model in a run-time environment).

In step 804, the model inference service system assembles a particular versioned model of the plurality of models from the model registry. For example, the model inference service system may assemble the particular model based on the versioned run-time dependencies associated with the particular model from one or more dependency repositories. The particular model may be a subsequent version (e.g., model 204-1) of a baseline model (e.g., baseline model 204) of the plurality of models. For example, the model inference service system can assemble the versioned run-time dependencies based on the dependency metadata of the particular model and/or one or more computing resources of a computing environment executing the instances of the particular model. The computing resources can include system memory (e.g., memory of a model processing system including the model processing unit), system processors (e.g., CPUs of the model processing system), the model processing unit and/or the one or more additional model processing units), and the like. In some embodiments, a model registry module (e.g., model registry module 406) retrieves the run-time dependencies.

In step 806, a model processing unit (e.g., model processing unit module 608) executes an instance of a particular model (e.g., model instance 618 of model 614) of the plurality of models. For example, the particular model may be large language model. For example, the model processing unit may be a single GPU or multiple GPUs. The model inference service system may instruct the model processing unit to execute the instance of the particular model on the model processing unit. For example, a model deployment module (e.g., model deployment module 418) may instruct the model processing unit to execute the instance of the particular model on the model processing unit.

In step 808, the model inference service system monitors a volume of requests received by the particular model. In some embodiments, a monitoring module (e.g., monitoring module 422) monitors the volume of requests. In step 810, the model inference service system monitors utilization (e.g., computing resource consumption) of the model processing unit. In some embodiments, the monitoring module monitors the utilization of the model processing unit. In step 812, the model inference service system detects, based on the monitoring, that the volume of requests satisfies a load-balancing threshold condition. For example, model inference service system may compare (e.g., continuously compare) the volume the requests with the load-balancing threshold condition and generate a notification when the load-balancing threshold condition is satisfied. In some embodiments, the monitoring module 422 detects the volume of requests satisfies a load-balancing threshold condition.

In step 814, the model inference service system automatically triggers execution (e.g., parallel execution) of one or more additional instances of the particular model on one or more additional model processing units. The model inference service system may perform the triggering in response to (and/or based on) the volume of requests and/or the utilization of the model processing unit. For example, the model inference service system can trigger one or more load-balancing operations in response to detecting the load-balancing threshold condition is satisfied. The one or more load balancing operations includes the automatic execution of the one or more additional instances of the particular model on the one or more additional processing units. A load-balancing module (e.g., load-balancing module 428) may trigger the automatic execution of the one or more additional instances of the particular model.

In step 816, the model inference service system monitors a volume of requests received by the one or more additional instances of the particular model. In some embodiments, the monitoring module 422 monitors the volume of requests received by the one or more additional instances of the particular model. In step 818, the model inference service system monitors utilization of the one or more additional model processing units. In some embodiments, the monitoring module monitors the utilization of the one or more additional model processing units.

In step 820, the model inference service system detects whether another load-balancing threshold condition is satisfied. For example, the model inference service system may perform the detection based on the monitoring of the volume of requests received by the one or more additional instances of the particular model and/or the utilization of the one or more additional model processing units. In step 822, the model inference service system triggers, in response to detecting the other load-balancing threshold condition is satisfied, one or more other load-balancing operations, wherein the one or more other load-balancing operations includes automatically terminating execution of the one or more additional instances of the particular model on the one or more additional processing units. In various embodiments, the model inference service system can use predicted values (e.g., predicted volume of received requests, predicted utilization of model processing systems and/or model processing units) instead of, or in addition to, the monitored values (e.g., monitored volume of requests, monitored utilization model processing units) to perform the functionality described herein.

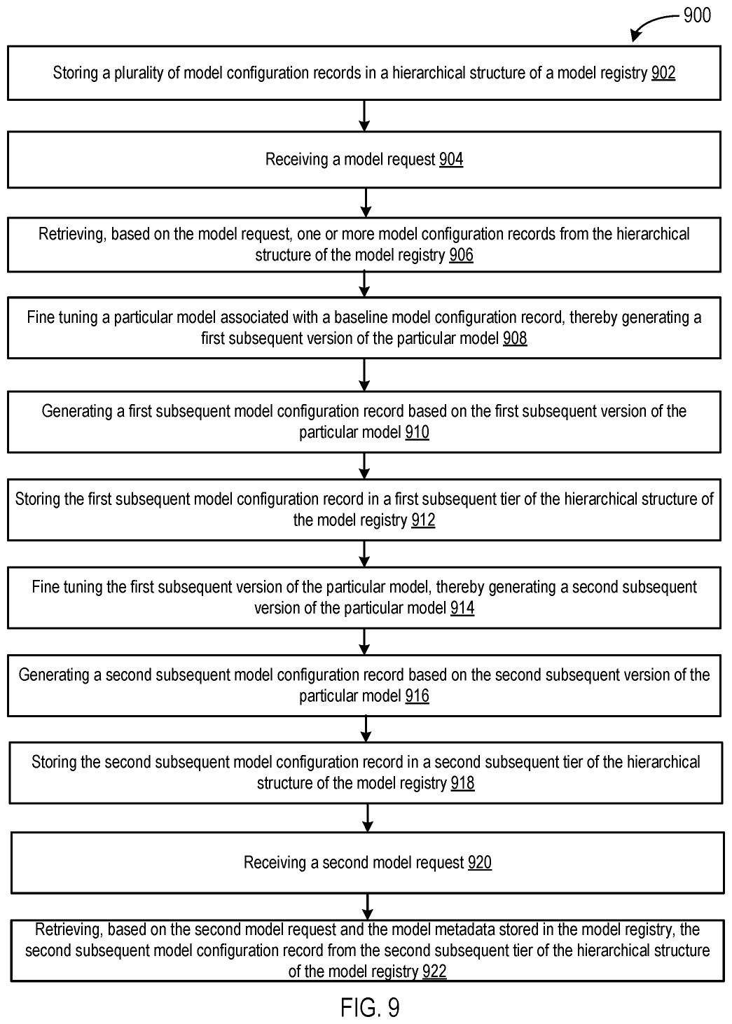

FIG. 9 depicts a flowchart 900 of an example method of operation of a model registry according to some embodiments. In this and other flowcharts and/or sequence diagrams, the flowchart illustrates by way of example a sequence of steps. In step 902, a model registry (e.g., model registry 310) stores a plurality of model configuration records (e.g., model configuration record 204) in a hierarchical structure of a model registry (e.g., as shown in FIGS. 2A and 2B). The model configuration records can be for any time of model (e.g., large language model and/or other modalities or multimodal machine learning models). In some embodiments, a model inference service system (e.g., model inference service system 400) instructs the model registry to store the model configuration records. For example, a model registry module (e.g., model registry module 406) may manage the model registry (e.g., performing storing instructions, retrieval instructions, and the like).

In step 904, the model registry receives a model request. The model inference service system may provide the model request to the model registry. For example, the model inference service system may receive an input from another system and/or user, select a model based on that request, and then request the selected model from the model registry. The model registry module may select the model and/or generate the model request. In another example, the model request may be received from another system or user, and the model registry may retrieve the appropriate model. For example, a model request may specify a particular model to retrieve. In some embodiments, the model registry can include functionality of the model inference service system.

In step 906, the model registry retrieves, based on the model request, one or more model configuration records (e.g., model configuration record 204-2) from the hierarchical structure of the model registry. In step 908, the model inference service system fine tunes a particular model associated with a baseline model configuration record, thereby generating a first subsequent version of the particular model. In some embodiments, a model generation module (e.g., model generation module 404) performs the fine tuning. In step 910, the model inference service system generates a first subsequent model configuration record based on the first subsequent version of the particular model. In some embodiments, the model generation module generates the first subsequent model configuration record.

In step 912, the model registry stores the first subsequent model configuration record in a first subsequent tier of the hierarchical structure of the model registry. In some embodiments, the model registry module causes the first subsequent model configuration record to be stored in the model registry. In step 914, the model inference service system fine tunes the first subsequent version of the particular model, thereby generating a second subsequent version of the particular model. In some embodiments, the model generation module performs the fine tuning. In step 916, the model inference service system generates a second subsequent model configuration record based on the second subsequent version of the particular model. In some embodiments, the model inference service system generates the second subsequent model configuration record.

In step 918, the model registry stores the second subsequent model configuration record in a second subsequent tier of the hierarchical structure of the model registry. In some embodiments, the model registry module causes the model registry to store the second subsequent model configuration record. In step 920, the model registry receives a second model request. In step 922, the model registry retrieves, based on the second model request and the model metadata stored in the model registry, the second subsequent model configuration record from the second subsequent tier of the hierarchical structure of the model registry.

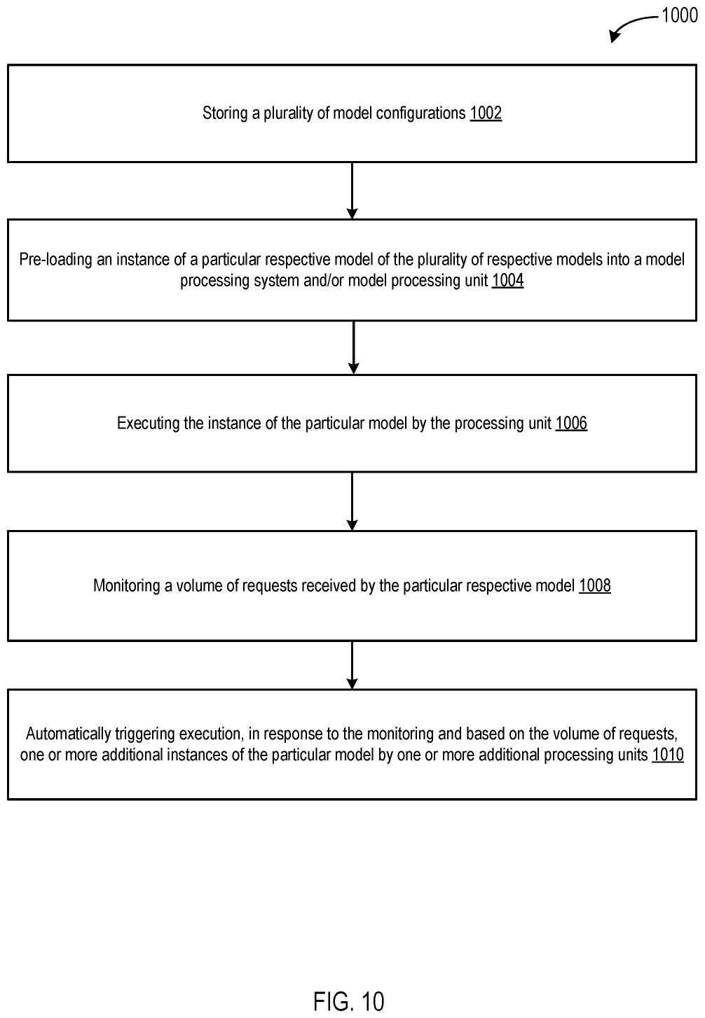

FIG. 10 depicts a flowchart 1000 of an example method of model administration according to some embodiments. In this and other flowcharts and/or sequence diagrams, the flowchart illustrates by way of example a sequence of steps. In step 1002, a model registry (e.g., model registry 310) stores a plurality of model configurations. Each of the model configurations can include model parameters of a model, and model metadata associated with the model, and dependency metadata associated with the model. The dependency metadata can indicate run-time dependencies associated with respective model. In step 1004, the model inference service system pre-loads an instance of a particular respective model of the plurality of respective models into a model processing system (e.g., computing system 602) and/or model processing unit (e.g., model processing unit 608). In some embodiments, a model deployment module (e.g., model deployment module 418) pre-loads the instance of the particular model.

In step 1006, the model processing unit executes the instance of the particular model by the processing unit. Executing the instance can include executing code of the particular respective model and code of the respective run-dependencies associated with the particular respective model. In step 1008, the model inference service system monitors a volume of requests received by the particular respective model. In some embodiments, a monitoring module (e.g., monitoring module 422) performs the monitoring. In step 1010, the model inference service system automatically triggers execution, in response to the monitoring and based on the volume of requests, one or more additional instances of the particular model by one or more additional processing units. In some embodiments, a load-balancing module (e.g., load-balancing module 428) automatically triggers the execution.

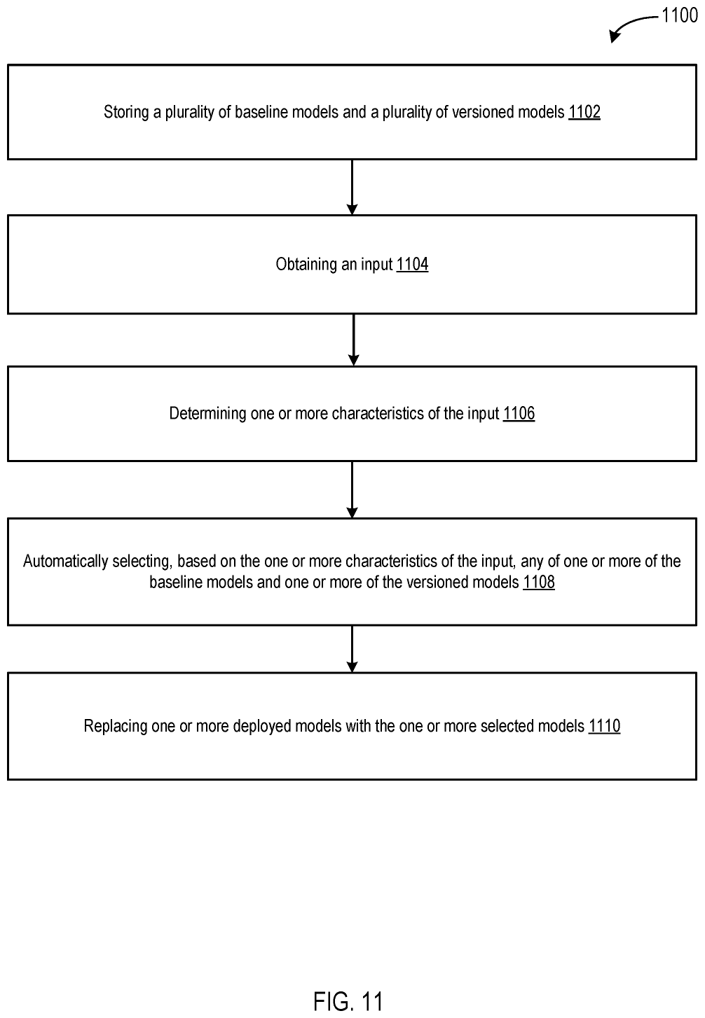

FIG. 11 depicts a flowchart 1100 of an example method of model swapping according to some embodiments. In this and other flowcharts and/or sequence diagrams, the flowchart illustrates by way of example a sequence of steps. In step 1102, a model registry (e.g., model registry 310) stores a plurality of baseline models and a plurality of versioned models. Each of the plurality of versioned models includes a baseline model that has been trained on a respective domain-specific dataset. In step 1104, a computing system (e.g., model inference service system 304, enterprise system 306, and/or the like) obtains an input. In step 1106, a model inference service system (e.g., model inference service system 304) determines one or more characteristics of the input. In some embodiments, a model swapping module (e.g., model swapping module 430) determines the characteristics of the input.

In step 1108, the model inference service system automatically selects, based on the one or more characteristics of the input, any of one or more of the baseline models and one or more of the versioned models. In some embodiments, each of the selected one or more models are trained on customer-specific data subsequent to being trained on the domain-specific dataset. In some embodiments, the model swapping module automatically selected the models.

In step 1110, the model inference service system replaces one or more deployed models with the one or more selected models. The one or more models may be selected and/or replaced at run-time. This can include, for example, terminating execution of the deployed models and executing the selected models on the same model processing units and/or different model processing units (e.g., based on current or predicted request volume, model processing system or model processing unit utilization, and the like). In some embodiments, the model swapping module replaces the deployed models with the selected models.

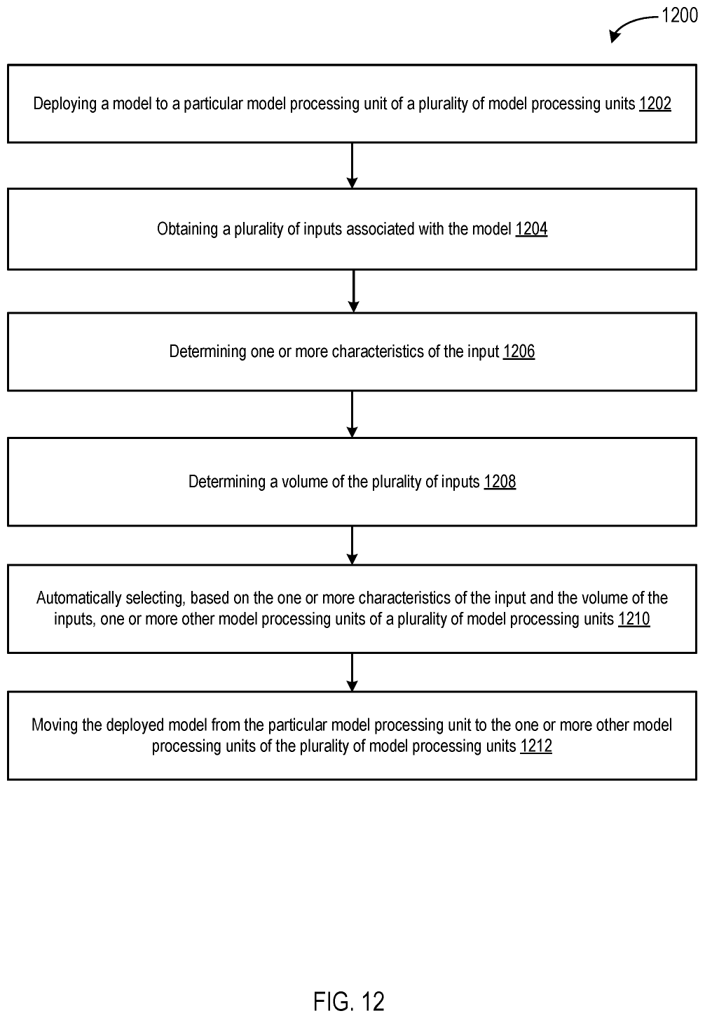

FIG. 12 depicts a flowchart 1200 of an example method of model processing system and/or model processing unit swapping according to some embodiments. In this and other flowcharts and/or sequence diagrams, the flowchart illustrates by way of example a sequence of steps. In step 1202, a model inference service system (e.g., model inference service system 400) deploys a model to a particular model processing unit of a plurality of model processing units. In some embodiments, a model deployment module (e.g., model deployment module 418) selects the particular model processing unit based on predicted utilization of the model (e.g., predicted volume of request the model will receive) and deploys the model. In step 1204, the model inference service system obtains a plurality of inputs (e.g., model requests) associated with the model. In some embodiments, an interface module (e.g., interface module 436) obtains the inputs from one or more applications (e.g., 112), users, and/or systems.

In step 1206, the model inference service system determines one or more characteristics of the input. In some embodiments, a model swapping module (e.g., model swapping module 430) determines the characteristics. In step 1208, the model inference service system determines a volume of the plurality of inputs. In some embodiments, a monitoring module (e.g., monitoring module 422) determines the volume. In step 1210, the model inference service system automatically selects, based on the one or more characteristics of the input and the volume of the inputs, one or more other model processing units of a plurality of model processing units. In some embodiments, the model swapping module automatically selects the other model processing units. In step 1212, the model inference service system moves the deployed model from the particular model processing unit to the one or more other model processing units of the plurality of model processing units. This can include terminating execution of the of the deployed model on the particular model processing unit and/or triggering an execution of one or more instances of the deployed model on the other model processing units. In some embodiments, the model swapping module moves the deployed model.

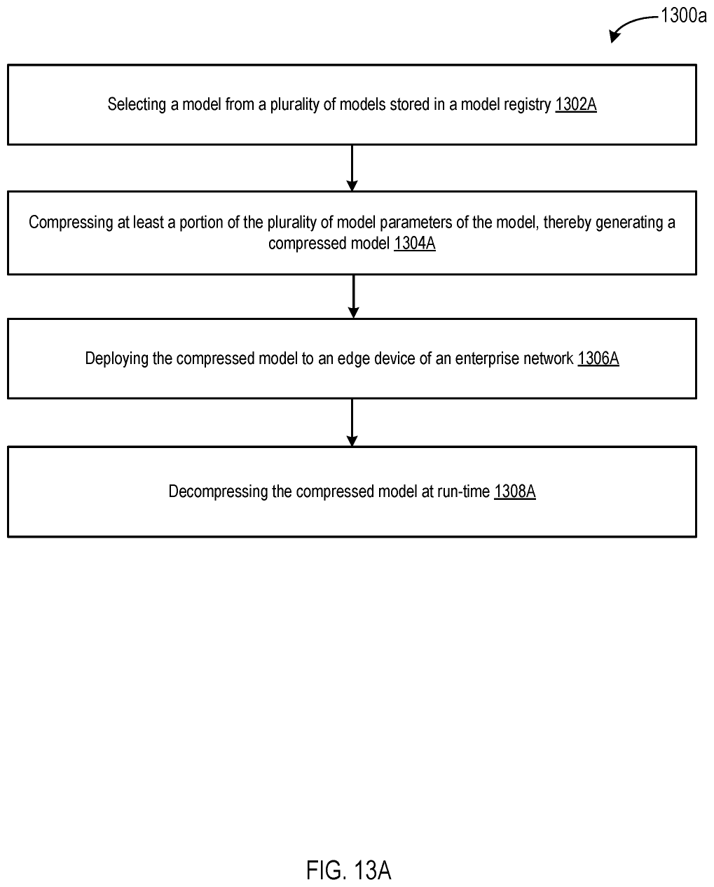

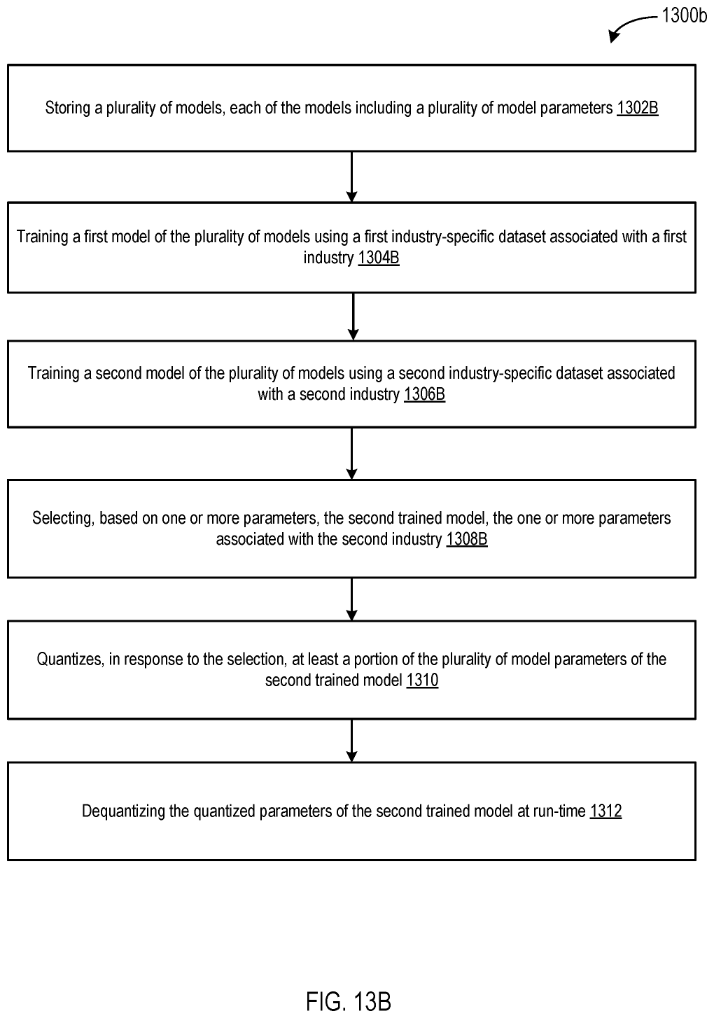

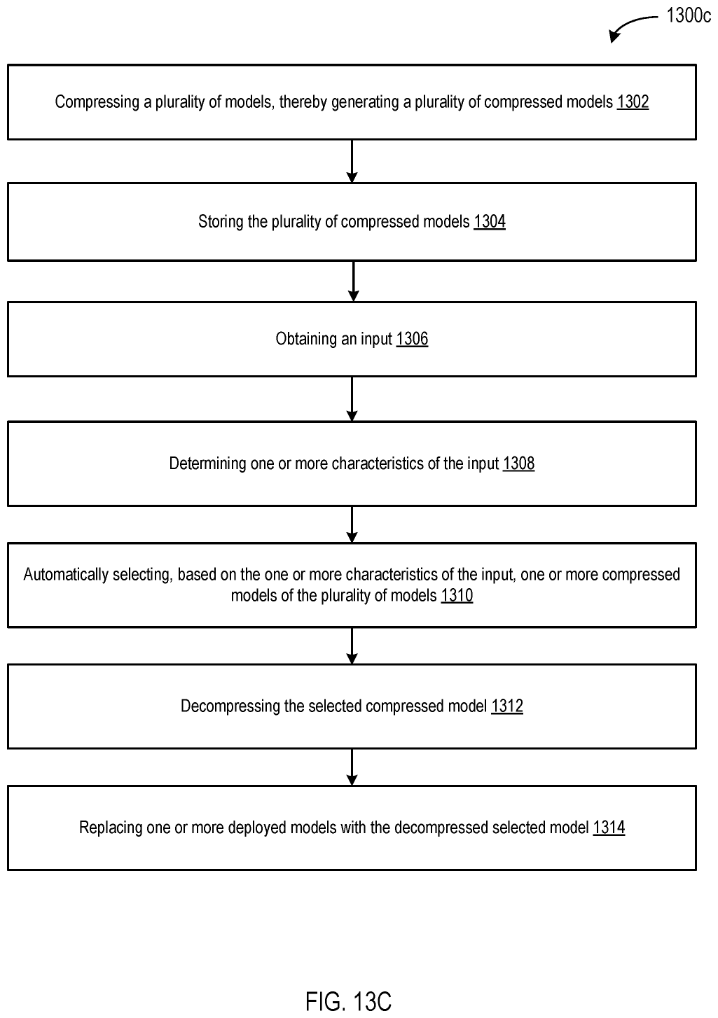

FIG. 13A depicts a flowchart 1300a of an example method of model compression and decompression according to some embodiments. In this and other flowcharts and/or sequence diagrams, the flowchart illustrates by way of example a sequence of steps. In step 1302a, a model inference service system (e.g., model inference service system 400) selects a model from a plurality of models stored in a model registry. The model can include a plurality of model parameters, model metadata, and/or dependency metadata. Model parameters can be numerical values, such as weights. A model can refer to an executable program with many different parameters (e.g., weights and/or biases). For example, a model can be an executable program generated using one or more machine learning algorithms and the model can have billions of weights. Weights can include statistical weights. Accordingly, the model registry may store executable programs. A model (e.g., a model stored in a model registry) may also refer to model parameters (e.g., weights) without the associated code (e.g., executable code). Accordingly, the model registry may store the model parameters without storing any code for executing the model. The code may be obtained by the model inference service system at or before run-time and combined with the parameters and any dependencies to execute an instance of the model.

In step 1304a, the model inference service system compresses at least a portion of the plurality of model parameters of the model, thereby generating a compressed model. In some embodiments, a model compression module (e.g., model compression module 412) performs the compression. In step 1306a, the model inference service system deploys the compressed model to an edge device of an enterprise network. In some embodiments, a model deployment module (e.g., model deployment module 418) deployed the compressed model. In step 1308a, the edge device decompresses the compressed model at run-time. For example, the edge device may dequantize a quantized model. In another example, the model may be decompressed prior to being loaded on the edge device.

FIG. 13B depicts a flowchart 1300b of an example method of model compression and decompression according to some embodiments. In this and other flowcharts and/or sequence diagrams, the flowchart illustrates by way of example a sequence of steps. In step 1302b, the model registry (e.g., model registry 202) stores a plurality of models (e.g., model 112, 114, 204, and the like). Each of the models can include a plurality of model parameters. In step 1304b, the model inference service system trains a first model (e.g., model 204-1) of the plurality of models using a first industry-specific dataset associated with a first industry. In some embodiments, a model generation module (e.g., model generation module 404) trains the model.

In step 1306b, the model inference service system trains a second model (e.g., model 204-2) of the plurality of models using a second industry-specific dataset associated with a second industry. In some embodiments, the model generation module trains the model. In step 1308b, the model inference service system selects, based on one or more parameters, the second trained model. The one or more parameters may be associated with the second industry. In some embodiments, a model deployment module (e.g., model deployment module 418) selects the model.

In step 1310b, the model inference service system quantizes, in response to the selection, at least a portion of the plurality of model parameters of the second trained model. In some embodiments, a model compression module (e.g., model compression module 412) performs the compression. In step 1312b, the model inference service system deploys the compressed second trained model to an edge device of an enterprise network. In some embodiments, the model deployment module 418 deploys the compressed model. In step 1314b, a model processing system (e.g., computing system 602) dequantizes the quantized model parameters of the second trained model at run-time. FIG. 13C depicts a flowchart 1300c of an example method of model compression and decompression according to some embodiments. In this and other flowcharts and/or sequence diagrams, the flowchart illustrates by way of example a sequence of steps.

In step 1302c, a model inference service system (e.g., model inference service system 400) compresses a plurality of models, thereby generating a plurality of compressed models, wherein each of the models is trained on a different domain-specific dataset, and wherein the compressed models include compressed model parameters. In some embodiments, a model compression module (e.g., model compression module 412) performs the compression.

In step 1304c, a model registry (e.g., model registry 310) stores the plurality of compressed models. In step 1306c, the model inference service system obtains an input (e.g., a model request). In some embodiments, an interface module (e.g., interface module 436) obtains input from one or more applications (e.g., applications 116), users, and/or systems. In step 1308c, the model inference service system determines one or more characteristics of the input. In some embodiments, a model deployment module (e.g., model deployment module 418) determines the characteristics of the input. In step 1310c, the model inference service system automatically selects, based on the one or more characteristics of the input, one or more compressed models of the plurality of models. In step 1312c, a model processing system decompresses the selected compressed model. In some embodiments, the model deployment module selects the compressed model.

In step 1314c, the model inference service system replaces one or more deployed models with the decompressed selected model. In some embodiments, a model swapping module (e.g., model swapping module 430) replaces the deployed models. This can include, for example, terminating execution of the deployed models and triggering an execution of the decompressed selected model on the same model processing unit and/or other model processing unit.

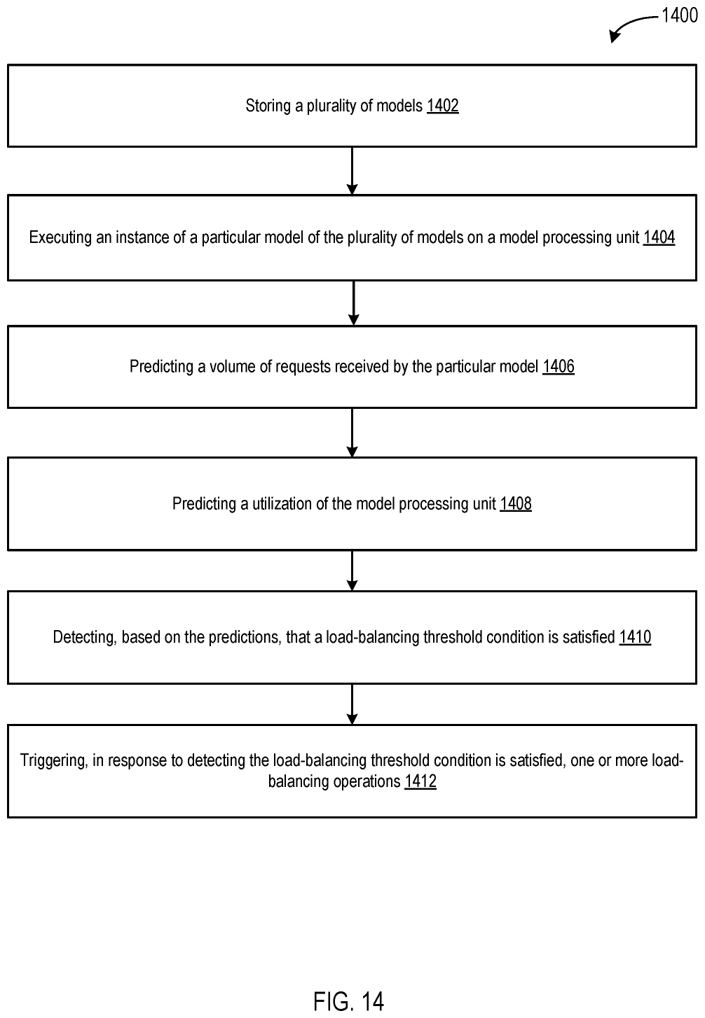

FIG. 14 depicts a flowchart 1400 of an example method of predictive model load balancing according to some embodiments. In this and other flowcharts and/or sequence diagrams, the flowchart illustrates by way of example a sequence of steps. In step 1402, a model registry (e.g., model registry 310) stores a plurality of models. In step 1404, a model processing system (e.g., computing system 602) executes an instance of a particular model of the plurality of models on a model processing unit.

In step 1406, a model inference service system (e.g., model inference service system 400) predicts a volume of requests received by the particular model. In some embodiments, a request prediction module (e.g., request prediction module 424) performs the predicts the volume of requests. In step 1408, the model inference service system predicts utilization of the model processing unit. In some embodiments, the request prediction module 424 predicts the utilization of the model processing unit.

In step 1410, the model inference service system detects, based on the predictions, that a load-balancing threshold condition is satisfied. In some embodiments, a load-balancing module (e.g., load-balancing module 428) detects the load-balancing threshold condition is satisfied.

In step 1412, the model inference service system triggers, in response to detecting the load-balancing threshold condition is satisfied, one or more load-balancing operations. The one or more load balancing operations can include automatically executing, in response to and based on the predicted volume of requests and the predicted utilization of the model processing unit, one or more additional instances of the particular model on one or more additional model processing units. In some embodiments, the load-balancing module triggers the load-balancing operations.

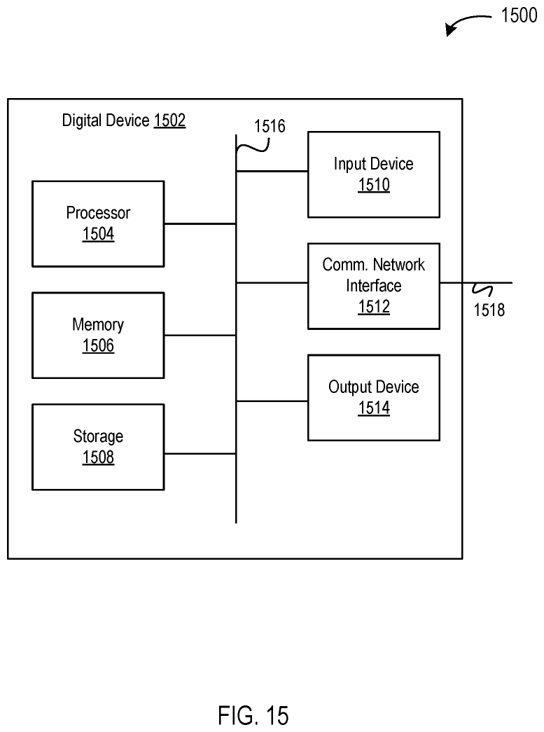

FIG. 15 depicts a diagram 1500 of an example of a computing device 1502. Any of the systems, engines, datastores, and/or networks described herein may comprise an instance of one or more computing devices 1502. In some embodiments, functionality of the computing device 1502 is improved to the perform some or all of the functionality described herein. The computing device 1502 comprises a processor 1504, memory 1506, storage 1508, an input device 1510, a communication network interface 1512, and an output device 1514 communicatively coupled to a communication channel 1516. The processor 1504 is configured to execute executable instructions (e.g., programs). In some embodiments, the processor 1504 comprises circuitry or any processor capable of processing the executable instructions.

The memory 1506 stores data. Some examples of memory 1506 include storage devices, such as RAM, ROM, RAM cache, virtual memory, etc. In various embodiments, working data is stored within the memory 1506. The data within the memory 1506 may be cleared or ultimately transferred to the storage 1508. The storage 1508 includes any storage configured to retrieve and store data. Some examples of the storage 1508 include flash drives, hard drives, optical drives, cloud storage, and/or magnetic tape. Each of the memory system 1506 and the storage system 1508 comprises a computer-readable medium, which stores instructions or programs executable by processor 1504.

The input device 1510 is any device that inputs data (e.g., mouse and keyboard). The output device 1514 outputs data (e.g., a speaker or display). It will be appreciated that the storage 1508, input device 1510, and output device 1514 may be optional. For example, the routers/switchers may comprise the processor 1504 and memory 1506 as well as a device to receive and output data (e.g., the communication network interface 1512 and/or the output device 1514).

The communication network interface 1512 may be coupled to a network (e.g., network 308) via the link 1518. The communication network interface 1512 may support communication over an Ethernet connection, a serial connection, a parallel connection, and/or an ATA connection. The communication network interface 1512 may also support wireless communication (e.g., 802.11 a/b/g/n, WiMax, LTE, Wi-Fi). It will be apparent that the communication network interface 1512 may support many wired and wireless standards.

It will be appreciated that the hardware elements of the computing device 1502 are not limited to those depicted in FIG. 15. A computing device 1502 may comprise more or less hardware, software and/or firmware components than those depicted (e.g., drivers, operating systems, touch screens, biometric analyzers, and/or the like). Further, hardware elements may share functionality and still be within various embodiments described herein. In one example, encoding and/or decoding may be performed by the processor 1504 and/or a co-processor located on a GPU (i.e., NVidia).

Example types of computing devices and/or processing devices include one or more microprocessors, microcontrollers, reduced instruction set computers (RISCs), complex instruction set computers (CISCs), graphics processing units (GPUs), data processing units (DPUs), virtual processing units, associative process units (APUs), tensor processing units (TPUs), vision processing units (VPUs), neuromorphic chips, AI chips, quantum processing units (QPUs), cerebras wafer-scale engines (WSEs), digital signal processors (DSPs), application specific integrated circuits (ASICs), field programmable gate arrays (FPGAs), or discrete circuitry.

It will be appreciated that a “module,” “engine,” “system,” “datastore,” and/or “database” may comprise software, hardware, firmware, and/or circuitry. In one example, one or more software programs comprising instructions capable of being executable by a processor may perform one or more of the functions of the engines, datastores, databases, or systems described herein. In another example, circuitry may perform the same or similar functions. Alternative embodiments may comprise more, less, or functionally equivalent engines, systems, datastores, or databases, and still be within the scope of present embodiments. For example, the functionality of the various systems, engines, datastores, and/or databases may be combined or divided differently. The datastore or database may include cloud storage. It will further be appreciated that the term “or,” as used herein, may be construed in either an inclusive or exclusive sense. Moreover, plural instances may be provided for resources, operations, or structures described herein as a single instance. It should be understood that some or all of the steps in the flow charts may be repeated, reorganized for parallel execution, and/or reordered, as applicable. Moreover, some steps in the flow charts that could have been included may have been removed to avoid providing too much information for the sake of clarity and some steps that were included could be removed but may have been included for the sake of illustrative clarity.

The datastores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

The systems, methods, engines, datastores, and/or databases described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The present invention(s) are described above with reference to example embodiments. It will be apparent to those skilled in the art that various modifications may be made, and other embodiments may be used without departing from the broader scope of the present invention(s). Therefore, these and other variations upon the example embodiments are intended to be covered by the present invention(s).

What is claimed:

1. A method comprising:
receiving a request associated with a machine learning application, wherein the request includes application information, user information, and execution information;
selecting, by one or more processing devices, a baseline model and one or more child model records from a hierarchical structure based on the request, wherein the baselines model and the one more child model records include model metadata with parameters describing dependencies, access control, and deployment configurations;
assembling a versioned model of the baseline model using the one more child model records and associated dependencies; and
deploying the versioned model in a configured run-time instantiation for use by the application based on the associated metadata.

2. The method of claim 1, wherein selecting comprises:
determining compatibility between the application information and execution information of the request with dependencies and deployment configurations from model metadata, and further determining access control of the model metadata and the user information of the request.

3. The method of claim 1,
wherein the child model records comprise intermediate representations of the baseline model with changed parameters from a previous instantiation of the baseline model.

4. The method of claim 1,
wherein the baseline model is pre-trained on a general domain dataset, and
wherein the one or more child model records comprise intermediate representations with changed parameters of the baseline model trained on an enterprise specific dataset.

5. The method of claim 1, wherein the deployment configurations determine a set of computing requirements for the run-time instance of the versioned model.

6. The method of claim 1, wherein assembling the versioned model further comprises: pre-loading a set of model configurations comprising at least one or more of: model weights, adapter instructions.

7. The method of claim 1, wherein the hierarchical structure comprises a catalogue of different baseline models that are pre-trained with different domain specific datasets, and child model records associated with each different baseline model are generated based on an intermediate record.

8. The method of claim 1, further comprising:
receiving multiple requests received for one or more additional instances of the versioned model;
deploying multiple instances of the versioned model;
capturing changes to the versioned model as new model records with new model metadata in the hierarchical repository.

9. The method of claim 8, further comprising:
monitoring utilization of one or more additional model processing units for the multiple instances of the versioned model; and
executing one or more load-balancing operations to terminate execution of the one or more additional instances of the versioned model based on a threshold condition of the computing environment.

10. The method of claim 1, wherein deploying the versioned model further comprises the machine learning application executing instructions to transmit control system commands for one or more industrial devices.

11. A system comprising:
memory storing instructions that, when executed by the one or more processors, cause the system to perform:
a model inference service for instantiating different versioned model to service a machine-learning application,
wherein a model registry comprises a hierarchical structure with a baselines model and child model records that include model metadata with parameters describing dependencies and deployment configurations to assemble the different versioned model, wherein each versioned model is assembled with the baseline model using the one more child model records and associated dependencies,
wherein the model inference service concurrently deploys multiple run-time instances with different versions of the model for different user sessions, and
wherein the model registry is updated with new model records based on the changes to the baseline model from multiple run-time instances.

12. The system of claim 11, wherein the versioned model for each user session of the different users is based at least on the users access control privileges of each user session.

13. The system of claim 11,
wherein the hierarchical repository comprises a catalogue of additional baseline models pretrained on datasets from different domains, and
wherein the additional model records associated with each additional baseline model is fine-tuned using local enterprise datasets.

14. The system of claim 11, the instantiating different versioned are capable of multiple generative tasks including conversational, summarizing, computational, predictive, visualization.

15. The system of claim 11, wherein the machine-learning application utilizes the versioned model, and wherein deploying the versioned model further comprises the machine learning application executing instructions to transmit control system commands for one or more industrial devices.

16. A method comprising:
storing a plurality of model configuration records in a hierarchical structure of a model registry;
receiving a model request; and
retrieving, based on the model request, one or more model configuration records from the hierarchical structure of the model registry.

17. The method of claim 16, wherein one or more versioned models are selected and replaced at run-time.

18. The method of claim 16, wherein each of the selected one or more models are pre-trained on customer-specific data subsequent to being trained on the domain-specific dataset.

19. The method of claim 16, further comprising:
compressing at least a portion of the plurality of model parameters of the model, thereby generating a compressed model;
deploying the compressed model to an edge device of an enterprise network;
decompressing the compressed model at run-time.

20. The method of claim 16, wherein the compressing comprises a quantization of at least a portion of the plurality of model parameters, and the decompressing comprises a dequantization of the plurality of quantized model parameters.
